(19) United States
(12) Patent Application Publication
(10) Pub. No.: US 2026/0139149 A1
(43) Pub. Date: May 21, 2026

(54) COMPOSITION

(71) Applicant: Merck Patent GMBH, Darmstadt (DE)

(72) Inventors: Chang-Suk Choi, Chungcheongnam-do (KR); Min-Ju Kim, Chungcheongnam-do (KR); Hyun-Jin Yoon, Dongan-gu (KR); Manuel Hamburger, Mannheim (DE)

(21) Appl. No.: 19/121,469

(22) PCT Filed: Oct. 18, 2023
(86) PCT No.: PCT/EP2023/078897

§ 371 Date: Apr. 16, 2025

(30) Foreign Application Priority Data
Oct. 21, 2022 (EP) 22202989.4

(51) Int. Cl. C09D 125/02; C09D 7/63

(52) U.S. Cl. CPC C09D 125/02; C09D 7/63

(57) ABSTRACT

The present invention relates to a composition containing a mono- or poly-cycloolefin like compound.

### FIELD OF THE INVENTION

The present invention relates to a composition containing a mono- or poly-cycloolefin like compound. The present invention further relates to a method for fabricating a film, a film, a device and use of a chemical compound.

### BACKGROUND ART

Electronic devices, especially organic electronic devices have become thinner and thinner over the years. These devices are generally encapsulated with optically transparent insulating materials.

U.S. Pat. No. 9,944,818 B2 discloses a two component mass polymerizable composition which is capable of tailoring to the desirable refractive index and is suitable as a filler and a protective coating material.

U.S. Ser. No. 11/230,624 B2 discloses a polycycloolefin monomers and catalyst activated by compound capable of generating photoacid as 3d printing materials.

### PATENT LITERATURE

1. U.S. Pat. No. 9,944,818 B2
2. U.S. Ser. No. 11/230,624 B2

### SUMMARY OF THE INVENTION

However, the inventors newly have found that there are still one or more of considerable problems for which improvement is desired, as listed below: higher transparency of the composition and/or an obtained film at visible light wavelength, lower haze value of an obtained film, lower dielectric constant of a composition and an obtained film, e.g. dielectric constant lower than 3 and low-loss lesser than 0.001 at high frequencies such as for example greater than 50 GHz, lower permittivity of a composition and an obtained film, improved touch sensitivity of an obtained film, high refractive index, good mechanical properties of an obtained film against mechanical stress such as folding and bending, good curing ratio of an composition, good thermal properties.

The inventors aimed to solve one or more of the above-mentioned problems.

The present inventors have surprisingly found that one or more of the above described technical problems can be solved by the features as defined in the claims.

Namely, it was found a novel composition comprising at least:
a) a chemical compound of formula (I):

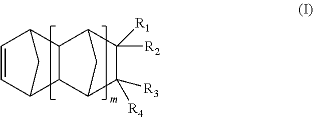

wherein:
m is an integer 0, 1 or 2; R₁, R₂, R₃ and R₄ are the same or different and each independently selected from the group consisting of hydrogen, halogen, methyl, ethyl, linear or branched (C₃-C₁₆)alkyl, perfluoro(C₁-C₁₂)alkyl, hydroxy(C₁-C₁₆)alkyl, (C₃-C₁₂)cycloalkyl, (C₆-C₁₂)bicycloalkyl, (C₇-C₁₄)tricycloalkyl, (C₆-C₁₀)aryl, (C₆-C₁₀)aryl(C₁-C₆)alkyl, perfluoro(C₆-C₁₀)aryl, perfluoro(C₆-C₁₀)aryl(C₁-C₆)alkyl, tri(C₁-C₆)alkoxysilyl and a group of formula (A):

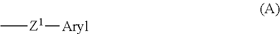

wherein:
Z¹ is a bond or a group selected from the group consisting of: (CR₅R₆)ₐ, O(CR₅R₆)ₐ, (CR₅R₆)ₐO, (CR₅R₆)ₐ—O—(CR₅R₆)_{b}, (CR₅R₆)ₐ—O—(SiR₅R₆)_{b}, (CR₅R₆)ₐ—(CO)O—(CR₅R₆)_{b}, (CR₅R₆)ₐ—O(CO)—(CR₅R₆)_{b}, (CR₅R₆)ₐ—(CO)—(CR₅R₆)_{b}, where a and b are integers which may be the same or different and each independently is 1 to 12;
R₅ and R₆ are the same or different and each independently selected from the group consisting of hydrogen, methyl, ethyl, linear or branched (C₃-C₆)alkyl, hydroxy, methoxy, ethoxy, linear or branched (C₃-C₆)alkyloxy, acetoxy, (C₂-C₆)acyl, hydroxymethyl, hydroxyethyl, linear or branched hydroxy(C₃-C₆)alkyl, phenyl and phenoxy;
Aryl is phenyl or phenyl substituted with one or more of groups selected from the group consisting of methyl, ethyl, linear or branched (C₃-C₆)alkyl, hydroxy, methoxy, ethoxy, linear or branched (C₃-C₆)alkyloxy, acetoxy, (C₂-C₆)acyl, hydroxymethyl, hydroxyethyl, linear or branched hydroxy(C₃-C₆)alkyl, phenyl and phenoxy;
b) an organo-ruthenium compound, preferably it is represented by formula (II):

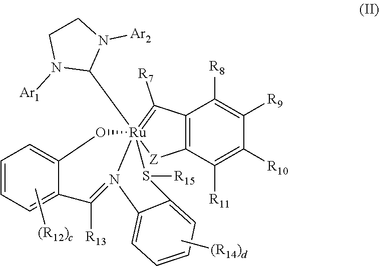

wherein
c and d are integers from 0 to 5;
Z is oxygen or sulfur;
R₇ is selected from the group consisting of hydrogen, (C₁-C₂₀)alkyl, (C₂-C₂₀)alkenyl, (C₂-C₂₀)alkynyl and (C₆-C₁₀)aryl; and
R₈, R₉, R₁₀ and R₁₁ are the same or different and each independently selected from the group consisting of hydrogen, halogen, (C₁-C₁₆)alkyl, (C₁-C₁₆)alkoxy, (C₁-C₁₆)perfluoroalkyl, (C₃-C₇)cycloalkyl, (C₂-C₁₆)alkenyl, (C₆-C₁₄)aryl, (C₆-C₁₄)perfluoroaryl,
(C₃-C₁₂)heterocyclyl, —OR₁₆, —NO₂, —COOH, —COOR₁₆, —CONR₁₆R₁₇, —SO₂NR₁₆R₁₇, —SO₂R₁₆, —CHO, —COR₁₆,
wherein R₁₆ and R₁₇ are the same or different and each independently selected from the group consisting of (C₁-C₆)alkyl, (C₁-C₆)perfluoroalkyl,
(C₆-C₁₄)aryl, (C₆-C₁₄)perfluoroaryl; or wherein two or more of R₈, R₉, R₁₀ and R₁₁ taken together with the carbon atoms to which they are attached to form a substituted or unsubstituted, fused (C₄-C₈)carbocyclic ring, or a substituted or unsubstituted, fused aromatic ring;
each R₁₂, R₁₃ and R₁₄ may be the same or different and independently of the other selected from the group consisting of hydrogen, halogen, (C₁-C₁₆)alkyl, (C₁-C₁₆)alkoxy, (C₁-C₁₆)perfluoroalkyl, (C₃-C₇)cycloalkyl, (C₂-C₁₆)alkenyl, (C₆-C₁₄)aryl,
(C₆-C₁₄)perfluoroaryl,(C₃-C₁₂)heterocyclyl, —OR₁₆, —NO₂, —COCH, —COOR₁₆, —CONR₁₆R₁₇, —SO₂NR₁₆R₁₇, —SO₂R₁₆, —CHO, —COR₁₆, wherein R₁₆ and R₁₇ are the same or different and each independently selected from the group consisting of (C₁-C₆)alkyl, (C₁-C₆)perfluoroalkyl, (C₆-C₁₄)aryl, (C₆-C₁₄)perfluoroaryl;
R₁₅ is selected from the group consisting of (C₁-C₁₆)alkyl, (C₁-C₁₆)perfluoroalkyl, (C₃-C₁₆)cycloalkyl, (C₆-C₁₄)aryl, (C₆-C₁₄)perfluoroaryl and (C₃-C₁₂)heterocyclyl;
Ar₁ and Ar₂ are the same or different and each independently selected from the group consisting of substituted or unsubstituted phenyl, substituted or unsubstituted biphenyl and substituted or unsubstituted naphthyl, wherein each of said substituents are independently selected from the group consisting of methyl, ethyl and linear or branched (C₃-C₆)alkyl;
c) a photosensitizer, preferably it is configured to bring the organo-ruthenium compound into its active form, preferably it is represented by formula (III):

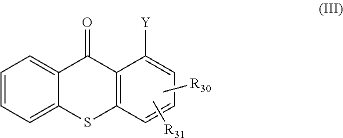

wherein
Y is halogen; and
R₃₀ and R₃₁ are the same or different and independently of each other selected from the group consisting of hydrogen, methyl, ethyl, linear or branched (C₃-C₁₂)alkyl, (C₃-C₁₂)cycloalkyl, (C₆-C₁₂)bicycloalkyl, (C₇-C₁₄)tricycloalkyl, (C₆-C₁₀)aryl, (C₆-C₁₀)aryl(C₁-C₃)alkyl, (C₁-C₁₂)alkoxy, (C₃-C₁₂)cycloalkoxy, (C₆-C₁₂)bicycloalkoxy, (C₇-C₁₄)tricycloalkoxy, (C₆-C₁₀)aryloxy(C₁-C₃)alkyl and (C₆-C₁₀)aryloxy; and
d) a chemical compound of formula (IV):

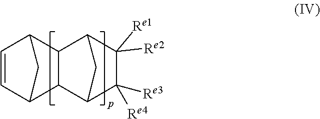

wherein
p is an integer 0, 1 or 2;
R^{e1}, R^{e2}, R^{e3} and R^{e4} are, each independently, selected from the group consisting of hydrogen, halogen, methyl, ethyl, linear (C₁-C₁₆)alkyl or branched (C₃-C₁₆)alkyl, perfluoro(C₁-C₁₂)alkyl, hydroxy(C₁-C₁₆)alkyl, (C₃-C₁₂)cycloalkyl, (C₆-C₁₂)bicycloalkyl, (C₇-C₁₄)tricycloalkyl, (C₆-C₁₀)aryl, (C₆-C₁₀)aryl(C₁-C₆)alkyl, perfluoro(C₆-C₁₀)aryl,
perfluoro(C₆-C₁₀)aryl(C₁-C₆)alkyl, tri(C₁-C₆)alkoxysilyl, vinyl group, acrylate group, methacrylate group and an allyl group, linear (C₁-C₁₆)alkyl or branched (C₃-C₁₆)alkyl having a vinyl group, acrylate group, methacrylate group or an allyl group as the end group;
wherein at least one of R^{e1}, R^{e2}, R^{e3} and R^{e4} is a vinyl group, acrylate group, methacrylate group, an allyl group, linear (C₁-C₁₆)alkyl or branched (C₃-C₁₆)alkyl having a vinyl group, acrylate group, methacrylate group or an allyl group as the end group.

### DETAILED DESCRIPTION

The terms as used herein have the following meanings: As used herein, the articles “a,” “an,” and “the” include plural referents unless otherwise expressly and unequivocally limited to one referent.

Since all numbers, values and/or expressions referring to quantities of ingredients, reaction conditions, etc., used herein and in the claims appended hereto, are subject to the various uncertainties of measurement encountered in obtaining such values, unless otherwise indicated, all are to be understood as modified in all instances by the term “about.”

Where a numerical range is disclosed herein such range is continuous, inclusive of both the minimum and maximum values of the range as well as every value between such minimum and maximum values. Still further, where a range refers to integers, every integer between the minimum and maximum values of such range is included. In addition, where multiple ranges are provided to describe a feature or characteristic, such ranges can be combined. That is to say that, unless otherwise indicated, all ranges disclosed herein are to be understood to encompass any and all sub-ranges subsumed therein.

For example, a stated range of from “1 to 10” should be considered to include any and all sub-ranges between the minimum value of 1 and the maximum value of 10. Exemplary sub-ranges of the range 1 to 10 include, but are not limited to, 1 to 6.1, 3.5 to 7.8, and 5.5 to 10, etc.

As used herein, “hydrocarbyl” refers to a group that contains carbon and hydrogen atoms, non-limiting examples being alkyl, cycloalkyl, aryl, aralkyl, alkaryl, and alkenyl. The term “halohydrocarbyl” refers to a hydrocarbyl group where at least one hydrogen has been replaced by a halogen. The term perhalocarbyl refers to a hydrocarbyl group where all hydrogens have been replaced by a halogen.

As used herein, the expression “alkyl” means a saturated, straight-chain or branched-chain hydrocarbon substituent having the specified number of carbon atoms. Particular alkyl groups are methyl, ethyl, n-propyl, isopropyl, n-butyl, iso-butyl, tert-butyl, and so on. Derived expressions such as “alkoxy”, “thioalkyl”, “alkoxyalkyl”, “hydroxyalkyl”, “alkylcarbonyl”, “alkoxycarbonylalkyl”, “alkoxycarbonyl”, “diphenylalkyl”, “phenylalkyl”, “phenylcarboxyalkyl” and “phenoxyalkyl” are to be construed accordingly.

As used herein, the expression “cycloalkyl” includes all of the known cyclic groups. Representative examples of “cycloalkyl” includes without any limitation cyclopropyl, cyclobutyl, cyclopentyl, cyclohexyl, cycloheptyl, cyclooctyl, and the like. Derived expressions such as “cycloalkoxy”, “cycloalkylalkyl”, “cycloalkylaryl”, “cycloalkylcarbonyl” are to be construed accordingly.

As used herein, the expression “perhaloalkyl” represents the alkyl, as defined above, wherein all of the hydrogen atoms in said alkyl group are replaced with halogen atoms selected from fluorine, chlorine, bromine or iodine. Illustrative examples include trifluoromethyl, trichloromethyl, tribromomethyl, triiodomethyl, pentafluoroethyl, pentachloroethyl, pentabromoethyl, pentaiodoethyl, and straight-chained or branched heptafluoropropyl, heptachloropropyl, heptabromopropyl, nonafluorobutyl, nonachlorobutyl, undecafluoropentyl, undecachloropentyl, tridecafluorohexyl, tridecachlorohexyl, and the like. Derived expression, “perhaloalkoxy”, is to be construed accordingly. It should further be noted that certain of the alkyl groups as described herein, such as for example, “alkyl” may partially be fluorinated, that is, only portions of the hydrogen atoms in said alkyl group are replaced with fluorine atoms and shall be construed accordingly.

As used herein the expression “acyl” shall have the same meaning as “alkanoyl”, which can also be represented structurally as “R-CO-,” where R is an “alkyl” as defined herein having the specified number of carbon atoms. Additionally, “alkylcarbonyl” shall mean same as “acyl” as defined herein. Specifically, “(C₁-C₄)acyl” shall mean formyl, acetyl or ethanoyl, propanoyl, n-butanoyl, etc. Derived expressions such as “acyloxy” and “acyloxyalkyl” are to be construed accordingly.

As used herein, the expression “aryl” means substituted or unsubstituted phenyl or naphthyl. Specific examples of substituted phenyl or naphthyl include o-, p-, m-tolyl, 1,2-, 1,3-, 1,4-xylyl, 1-methylnaphthyl, 2-methylnaphthyl, etc. “Substituted phenyl” or “substituted naphthyl” also include any of the possible substituents as further defined herein or one known in the art.

As used herein, the expression “arylalkyl” means that the aryl as defined herein is further attached to alkyl as defined herein. Representative examples include benzyl, phenylethyl, 2-phenylpropyl, 1-naphthylmethyl, 2-naphthylmethyl and the like.

As used herein, the expression “alkenyl” means a non-cyclic, straight or branched hydrocarbon chain having the specified number of carbon atoms and containing at least one carbon-carbon double bond, and includes ethenyl and straight-chained or branched propenyl, butenyl, pentenyl, hexenyl, and the like. Derived expression, “arylalkenyl” and five membered or six membered “heteroarylalkenyl” is to be construed accordingly. Illustrative examples of such derived expressions include furan-2-ethenyl, phenylethenyl, 4-methoxyphenylethenyl, and the like.

As used herein, the expression “heteroaryl” includes all of the known heteroatom containing aromatic radicals. Representative 5-membered heteroaryl radicals include furanyl, thienyl or thiophenyl, pyrrolyl, isopyrrolyl, pyrazolyl, imidazolyl, oxazolyl, thiazolyl, isothiazolyl, and the like.

Representative 6-membered heteroaryl radicals include pyridinyl, pyridazinyl, pyrimidinyl, pyrazinyl, triazinyl, and the like radicals. Representative examples of bicyclic heteroaryl radicals include, benzofuranyl, benzothiophenyl, indolyl, quinolinyl, isoquinolinyl, cinnolyl, benzimidazolyl, indazolyl, pyridofuranyl, pyridothienyl, and the like radicals. “Halogen” or “halo” means chloro, fluoro, bromo, and iodo.

In a broad sense, the term “substituted” is contemplated to include all permissible substituents of organic compounds. In a few of the specific embodiments as disclosed herein, the term “substituted” means substituted with one or more substituents independently selected from the group consisting of (C₁-C₆)alkyl, (C₂-C₆)alkenyl, (C₁-C₆)perfluoroalkyl, phenyl, hydroxy, —CO₂H, an ester, an amide, (C₁-C₆)alkoxy, (C₁-C₆)thioalkyl and (C₁-C₆)perfluoroalkoxy. However, any of the other suitable substituents known to one skilled in the art can also be used in these embodiments.

It should be noted that any atom with unsatisfied valences in the text, schemes, examples and tables herein is assumed to have the appropriate number of hydrogen atom(s) to satisfy such valences.

By the term “latent organo-transition metal catalyst” is meant organo-transition metal compounds that show little or no catalytic activity at a particular (usually ambient atmospheric conditions) temperature and initiate such activity either upon heat or light or both. Generally the catalytic activity of the catalyst can be kept latent for a prolonged periods of time, which can range from five days or longer especially when it is stored at room temperature or lower in a dark atmosphere. Higher temperatures and/or light may accelerate the catalytic activity.

By the term “actinic radiation” or “photolytic conditions” is meant subjecting the compositions of this invention to suitable “electromagnetic radiation,” which can be emitted from a laser, a digital processing (DLP) projector, a lamp, a light emitting diode (LED), a mercury arc lamp, a fiber optic, or liquid crystal display (LCD), and the like.

It will be understood that the terms “dielectric” and “insulating” are used interchangeably herein. Thus reference to an insulating material or layer is inclusive of a dielectric material or layer and vice versa. Further, as used herein, the term “organic electronic device” will be understood to be inclusive of the term “organic semiconductor device” and the several specific implementations of such devices used, for example, in electronic, automotive or other industries.

As used herein, the dielectric constant (Dk) of a material is the ratio of the charge stored in an insulating material placed between two metallic plates to the charge that can be stored when the insulating material is replaced by vacuum or air. It is also called as electric permittivity or simply permittivity. And, at times referred as relative permittivity, because it is measured relatively from the permittivity of free space.

As used herein, “low-loss” is the dissipation factor (Df), which is a measure of loss-rate of energy of a mode of oscillation (mechanical, electrical, or electromechanical) in a dissipative system. It is the reciprocal of quality factor, which represents the “quality” or durability of oscillation.

By the term “derived” is meant that the polymeric repeating units are polymerized (formed) from, for example, polycyclic norbornene-type monomers in accordance with formulae (I), (V) or (VI) wherein the resulting polymers are ring opened metathesis polymerized (ROMP), for example, the 2,3 double bond of norbornene-type monomers are ring opened and polymerized as shown below:

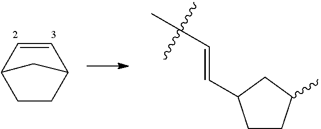

Accordingly, in accordance with the practice of this invention there is provided a composition comprising at least, essentially consisting of or consisting of:
a) a chemical compound of formula (I):

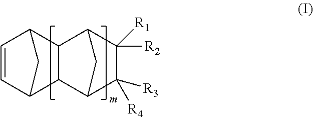

wherein:
m is an integer 0, 1 or 2;
R₁, R₂, R₃ and R₄ are the same or different and each independently selected from the group consisting of hydrogen, halogen, methyl, ethyl, linear or branched (C₃-C₁₆)alkyl, perfluoro(C₁-C₁₂)alkyl, hydroxy(C₁-C₁₆)alkyl, (C₃-C₁₂)cycloalkyl, (C₆-C₁₂)bicycloalkyl, (C₇-C₁₄)tricycloalkyl, (C₆-C₁₀)aryl, (C₆-C₁₀)aryl(C₁-C₆)alkyl, perfluoro(C₆-C₁₀)aryl, perfluoro(C₆-C₁₀)aryl(C₁-C₆)alkyl, tri(C₁-C₆)alkoxysilyl and a group of formula (A):

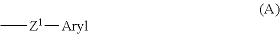

wherein:
Z is a bond or a group selected from the group consisting of: (CR₅R₆)ₐ, O(CR₅R₆)ₐ, (CR₅R₆)ₐO, (CR₅R₆)ₐ—O—(CR₅R₆)_{b}, (CR₅R₆)ₐ—O—(SiR₅R₆)_{b}, (CR₅R₆)ₐ—(CO)O—(CR₅R₆)_{b}, (CR₅R₆)ₐ—O(CO)—(CR₅R₆)_{b}, (CR₅R₆)ₐ—(CO)—(CR₅R₆)_{b}, where a and b are integers which may be the same or different and each independently is 1 to 12;
R₅ and R₆ are the same or different and each independently selected from the group consisting of hydrogen, methyl, ethyl, linear or branched (C₃-C₆)alkyl, hydroxy, methoxy, ethoxy, linear or branched (C₃-C₆)alkyloxy, acetoxy, (C₂-C₆)acyl, hydroxymethyl, hydroxyethyl, linear or branched hydroxy(C₃-C₆)alkyl, phenyl and phenoxy;
Aryl is phenyl or phenyl substituted with one or more of groups selected from the group consisting of methyl, ethyl, linear or branched (C₃-C₆)alkyl, hydroxy, methoxy, ethoxy, linear or branched (C₃-C₆)alkyloxy, acetoxy, (C₂-C₆)acyl, hydroxymethyl, hydroxyethyl, linear or branched hydroxy(C₃-C₆)alkyl, phenyl and phenoxy;
b) an organo-ruthenium compound, preferably it is represented by formula (II):

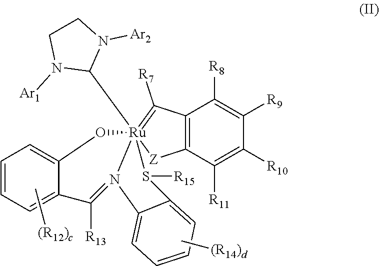

wherein
c and d are integers from 0 to 5;
Z is oxygen or sulfur;
R₇ is selected from the group consisting of hydrogen, (C₁-C₂₀)alkyl, (C₂-C₂₀)alkenyl, (C₂-C₂₀)alkynyl and (C₆-C₁₀)aryl; and
R₈, R₉, R₁₀ and R₁₁ are the same or different and each independently selected from the group consisting of hydrogen, halogen, (C₁-C₁₆)alkyl, (C₁-C₁₆)alkoxy, (C₁-C₁₆)perfluoroalkyl, (C₃-C₇)cycloalkyl, (C₂-C₁₆)alkenyl, (C₆-C₁₄)aryl, (C₆-C₁₄)perfluoroaryl,
(C₃-C₁₂)heterocyclyl, —OR₁₆, —NO₂, —COOH, —COOR₁₆, —CONR₁₆R₁₇, —SO₂NR 16R₁₇, —SO₂R₁₆, —CHO, —COR₁₆, wherein R₁₆ and R₁₇ are the same or different and each independently selected from the group consisting of (C₁-C₆)alkyl, (C₁-C₆)perfluoroalkyl, (C₆-C₁₄)aryl, (C₆-C₁₄)perfluoroaryl; or wherein
two or more of R₈, R₉, R₁₀ and R₁₁ taken together with the carbon atoms to which they are attached to form a substituted or unsubstituted, fused (C₄-C₈)carbocyclic ring, or a substituted or unsubstituted, fused aromatic ring;
each R₁₂, R₁₃ and R₁₄ may be the same or different and independently of the other selected from the group consisting of hydrogen, halogen, (C₁-C₁₆)alkyl, (C₁-C₁₆)alkoxy, (C₁-C₁₆)perfluoroalkyl, (C₃-C₇)cycloalkyl, (C₂-C₁₆)alkenyl, (C₆-C₁₄)aryl, (C₆-C₁₄)perfluoroaryl,
(C₃-C₁₂)heterocyclyl, —OR₁₆, —NO₂, —COOH, —COOR₁₆,
—CONR₁₆R₁₇, —SO₂NR₁₆R₁₇, —SO₂R₁₆, —CHO, —COR₁₆, wherein R₁₆ and R₁₇ are the same or different and each independently selected from the group consisting of (C₁-C₆)alkyl, (C₁-C₆)perfluoroalkyl, (C₆-C₁₄)aryl, (C₆-C₁₄)perfluoroaryl;
R₁₅ is selected from the group consisting of (C₁-C₁₆)alkyl,
(C₁-C₁₆)perfluoroalkyl, (C₃-C₁₆)cycloalkyl, (C₆-C₁₄)aryl, (C₆-C₁₄)perfluoroaryl and (C₃-C₁₂)heterocyclyl;
Ar₁ and Ar₂ are the same or different and each independently selected from the group consisting of substituted or unsubstituted phenyl, substituted or unsubstituted biphenyl and substituted or unsubstituted naphthyl, wherein each of said substituents are independently selected from the group consisting of methyl, ethyl and linear or branched (C₃-C₆)alkyl;
c) a photosensitizer, preferably it is configured to bring the organo-ruthenium compound into its active form, preferably it is represented by formula (III):

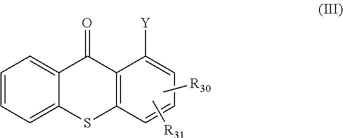

wherein
Y is halogen; and
R₃₀ and R₃₁ are the same or different and independently of each other selected from the group consisting of hydrogen, methyl, ethyl, linear or branched (C₃-C₁₂)alkyl, (C₃-C₁₂)cycloalkyl, (C₆-C₁₂)bicycloalkyl, (C₇-C₁₄)tricycloalkyl, (C₆-C₁₀)aryl, (C₆-C₁₀)aryl(C₁-C₃)alkyl, (C₁-C₁₂)alkoxy, (C₃-C₁₂)cycloalkoxy, (C₆-C₁₂)bicycloalkoxy, (C₇-C₁₄)tricycloalkoxy, (C₆-C₁₀)aryloxy(C₁-C₃)alkyl and (C₆-C₁₀)aryloxy; and
d) a chemical compound of formula (IV):

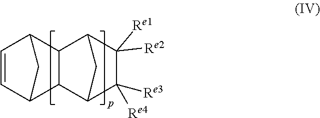

wherein
p is an integer 0, 1 or 2;
R^{e1}, R^{e2}, R^{e3} and R^{e4} are, each independently, selected from the group consisting of hydrogen, halogen, methyl, ethyl, linear (C₁-C₁₆)alkyl or branched (C₃-C₁₆)alkyl, perfluoro(C₁-C₁₂)alkyl, hydroxy(C₁-C₁₆)alkyl, (C₃-C₁₂)cycloalkyl, (C₆-C₁₂)bicycloalkyl, (C₇-C₁₄)tricycloalkyl, (C₆-C₁₀)aryl, (C₆-C₁₀)aryl(C₁-C₆)alkyl, perfluoro(C₆-C₁₀)aryl, perfluoro(C₆-C₁₀)aryl(C₁-C₆)alkyl, tri(C₁-C₆)alkoxysilyl, vinyl group, acrylate group, methacrylate group and an allyl group, linear (C₁-C₁₆)alkyl or branched (C₃-C₁₆)alkyl having a vinyl group, acrylate group, methacrylate group or an allyl group as the end group;
wherein at least one of R^{e1}, R^{e2}, R^{e3} and R^{e4} is a vinyl group, acrylate group, methacrylate group, an allyl group, linear (C₁-C₁₆)alkyl or branched (C₃-C₁₆)alkyl having a vinyl group, acrylate group, methacrylate group or an allyl group as the end group.

### Composition

It is believed that preferably, the compositions of this invention are stable at temperatures ranging from room temperature to 80° C., thus offering excellent shelf life stability. As used herein, “stable” means the composition of this invention remains clear without increase of any viscosity when kept at temperatures ranging from room temperature to 80° C., especially when kept in a dark atmosphere, such as for example, in amber or brown colored containers in the absence of any light. Accordingly, in some embodiments, the composition of this invention exhibits no viscosity change when stored at temperatures below 80° C. for a period of more than thirty (30) days.

Accordingly, in some embodiments, the composition of this invention exhibits less than five (5) percent viscosity increase when stored at temperatures below 80° C. for a period of more than forty (40) days. In some other embodiments, the composition of this invention exhibits less than ten (10) percent viscosity change when stored at temperatures below 80° C. for a period of sixty (60) days to ninety (90) days.

In some other embodiments, the composition of this invention exhibits less than twenty (20) percent viscosity change when stored at temperatures below 80° C. for a period of one-hundred twenty (120) days to one-hundred eighty (180) days. In some other embodiments, the composition of this invention exhibits less than two (2) percent viscosity change when stored at ambient temperatures, for example from about 20° C. to 25° C. for an extended period of time, which may range from about one-hundred twenty (120) days to three-hundred (300) days or longer.

That is, the viscosity of the composition remains essentially unchanged when stored at ambient temperature conditions, yet the composition undergoes mass polymerization as soon as it is exposed to suitable actinic radiation as evidenced by UV-DSC measurements which indicated that the heat of polymerization remained unchanged even after a composition is stored for an extended period of time as disclose hereinabove.

The monomers employed in the composition of this invention are themselves known in the literature or can be prepared by any of the known methods in the art to make such or similar types of monomers.

In addition, the monomers as described herein readily undergo mass polymerization, i.e., in their neat form without use of any solvents when polymerized under mass ring open metathesis polymerization (ROMP) conditions using certain transition metal catalysts, such as for example, organo-ruthenium and organo-osmium compounds. See for example, R. H. Grubbs et al., Handbook of Metathesis, Ed.: Wiley-VCH, Weinheim, Germany, 2003, R. H. Grubbs et al., Acc. Chem. Res. 2001, 34, 18-29, R. H. Grubbs et al., Angew. Chem. Int. Ed., 2006, 45, 3760-3765. Also, see U.S. Pat. No. 6,838,489, pertinent portions of which are incorporated herein by reference. The term “mass polymerization” as used herein shall have the generally accepted meaning in the art. That is, a polymerization reaction that is generally carried out substantially in the absence of a solvent.

In some cases, however, a small proportion of solvent is present in the reaction medium. For example, such small amounts of solvent may be used to dissolve the latent catalyst and/or the activator or convey the same to the reaction medium. Also, some solvent may be used to reduce the viscosity of the monomer. The amount of solvent that can be used in the reaction medium may be in the range of 0 to 5 weight percent based on the total weight of the monomers employed. Any of the suitable solvents that dissolves the catalyst, activator and/or monomers can be employed in this invention. Examples of such solvents include alkanes, cycloalkane, toluene, THF, dichloromethane, dichloroethane, and the like.

Advantageously, it has now been found that one or more of the monomers themselves can be used to dissolve the latent catalyst as well as the activator and thus avoiding the need for the use of solvents. In addition, one monomer can itself serve as a solvent for the other monomer and thus eliminating the need for an additional solvent. For example, if first monomer of formula (I) is a solid at room temperature, then the second monomer of formula (I), which is liquid at room temperature can be used as a solvent for the first monomer of formula (I) which is a solid or vice versa. Therefore, in such situations more than one monomer can be employed in the composition of this invention.

In general, the composition of this invention exhibits low viscosity at room temperature, which can be below 100 centipoise or lower. In some embodiments, the viscosity at room temperature of the composition of this invention is less than 80 centipoise. In some other embodiments the viscosity at room temperature of the composition of this invention is in the range from about 10 to 100 centipoise. In yet some other embodiments the viscosity at room temperature of the composition of this invention is lower than 70 cP, lower than 60 cP, lower than 40 cP, lower than 20 cP at room temperature. In some other embodiments it may even be lower than 10 cP and may vary from as low as 3 cP to 9 cP at room temperature.

Accordingly, the compositions of this invention can also include other high refractive polymeric materials and/or nanoparticles which will bring about such intended benefit. Examples of such polymers include without any limitation, poly(-methylstyrene), poly(vinyl-toluene), copolymers of—methylstyrene and vinyl-toluene, and the like. Examples of such nanoparticles include without any limitation, organic or inorganic nanoparticles in a size range of 1-100 nm including materials like crosslinked poly(styrene), crosslinked poly(methacrylates), metal oxides (e.g. zinc oxide, magnesium oxide, titanium oxide), silicon, silicon oxide, silicon nitride, and luminescent materials (e.g. III-V semiconductor nanoparticles like indium phosphide).

### Chemical Compound of Formula (I):

In some embodiments of the present invention, the refractive index of the monomers of formula (I) is 1.5 or more. In some other embodiments the refractive index of the monomers of formula (I) is in the range from about 1.5 to 1.6. In yet some other embodiments the refractive index of the monomers of formula (I) is 1.55 or more, 1.6 or more, or 1.65 or more. In some other embodiments it may even be 1.7 or more. And preferably 2.0 or less.

It is believed that the monomer(s) of formula (I) may also serve as high refractive index materials imparting high refractive index to the resulting polymeric film upon mass polymerization at a temperature and/or condition different from the application of the composition onto a desirable substrate.

When the composition of this invention contains two or more monomers, for example, they can be present in any desirable amounts that would bring about intended benefit, including either refractive index modification or viscosity modification or both.

In general, the compositions in accordance with the present invention encompass the above described one or more of the monomer of formula (I) and if needed additional monomers of formula (I) distinct from each other, as it will be seen below, various composition embodiments are selected to provide properties to such embodiments that are appropriate and desirable for the use for which such embodiments are directed, thus such embodiments are tailorable to a variety of specific applications.

For example, as already discussed above, proper combination of distinctive monomers of formula (I) makes it possible to tailor a composition having the desirable refractive index, viscosity and optical transmission properties. In addition, as described further herein it may be desirable to include other polymeric or monomeric materials, such as for example inorganic nanoparticles which are compatible to provide desirable optical properties depending upon the end use application.

Accordingly, in a preferable embodiment of the present invention, the monomer(s) of formula (I) is selected from the following:

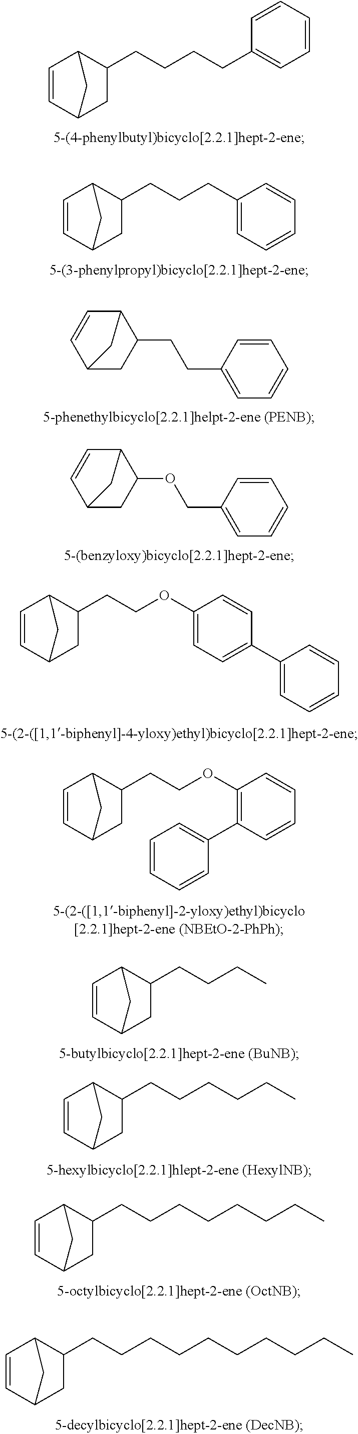

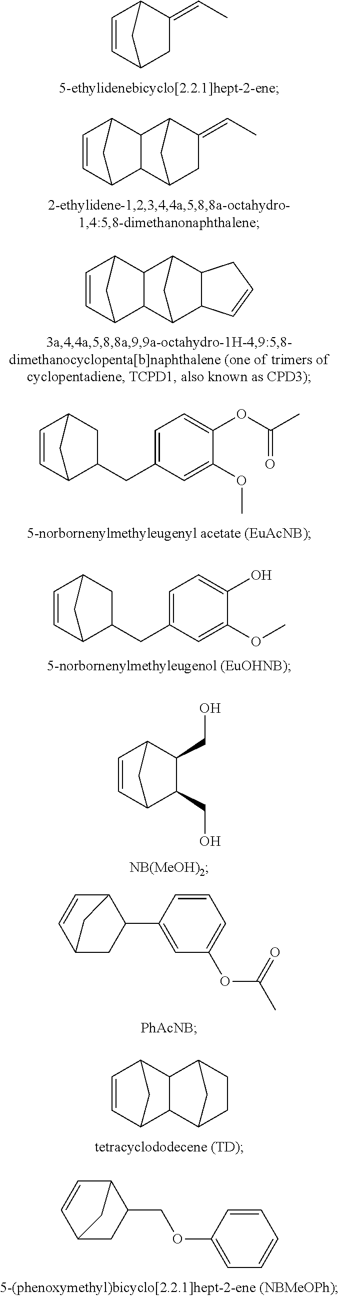

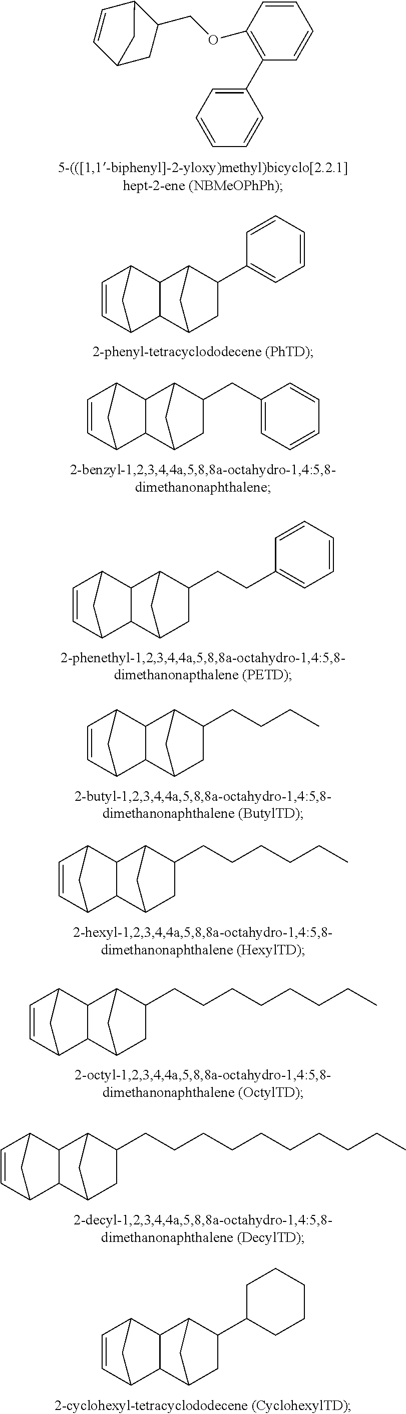

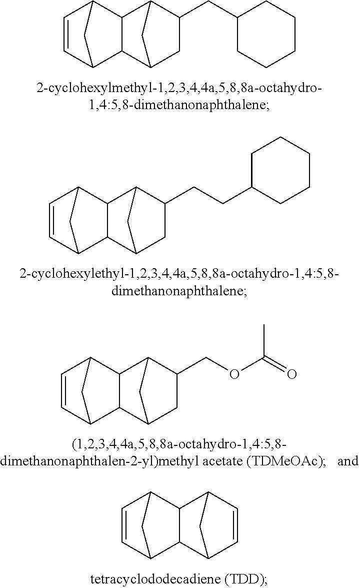

As noted, preferably, the monomer of formula (I) is having a refractive index of at least 1.5. The composition is in a clear liquid form at room temperature.

### Organo-Ruthenium Compound

As noted, the composition of this invention contains at least one organo-ruthenium compound, preferably it is represented by formulae (II), that would bring about the mass polymerization as described herein under ROMP conditions when the composition is subjected to suitable actinic radiation. Generally, such an organo-ruthenium compound, preferably represented by formulae (II), is “latent” and become active only under certain conditions. Again, as used herein the term “latent” means that the organo-ruthenium catalyst used in the composition of this invention remains inactive for a prolonged period of time when the composition of this invention is stored at ambient conditions to temperatures up to 80° C. Accordingly, in some embodiments the organo-ruthenium catalysts remain latent for a period of more than thirty (30) days when stored at temperatures below 80° C. In some other embodiments, the organo-ruthenium catalyst remains latent for a period of forty (40) days to ninety (90) days when stored at temperatures below 50° C.

Generally, any of the latent organo-ruthenium compound, preferably represented by formulae (II), that would bring about ring open metathesis polymerization of the monomers of formulae (I) or (V) or (VI) can be employed in the composition of this invention. Interestingly, it has now been found that organo-ruthenium compounds of formula (II) are very stable at temperatures from about 25° C. (i.e., ambient conditions) up to a temperature of about 80° C. and can be stored as such or in the presence of one or more monomers of formulae (I) or (V) or (VI) for several days even including up to three to six months or even longer. That is, the organo-ruthenium compounds of formula (II) preferably serve as latent catalysts that are stable at or near room temperature to elevated temperatures of up to 80° C. and yet can be readily activated by a variety of conditions, including without any limitation thermal, acid, light and chemical activation only when needed. The chemical activation may include use of thermal acid generator or photo acid generators.

Several of the latent catalysts that are known in the literature are not stable under the conditions specified herein and most of them do not exhibit the required shelf life stability as described herein. See for example, Grubbs, et al., Organometallics, 2011, 30 (24): 6713-6717; Sutar et al., Angew. Chem. Int. Ed. 2016, 55, 764-767; Leitgeh, et al., Monatsh Chem (2014) 145:1513-1517; van Hensbergen, et al., J. Mater. Chem. C. 2015, 3, 693-702; Grubbs, et al., J. Am. Chem. Soc., 2009, 131, 203802039; Zak, et al., Eur. J. Inorg. Chem., 2014, 1131-1136; Gawin, et al., ACS Catal. 2017, 7, 5443-5449. Further examples of such catalysts can also be found in U.S. Pat. No. 9,328,132, pertinent portions of which are incorporated herein by reference. Accordingly, the compositions encompassing the organo-ruthenium compounds of formula (II) provide hitherto unattainable advantages in various applications as described herein.

According to the present invention, such a organo-ruthenium compound can be any publicly available one. The organo-ruthenium compound like described in U.S. Ser. No. 11/230,624 B2 may also be used. Preferably, it is a compound of formulae (II), wherein:
Z is oxygen;
R₇ is hydrogen;
R₈, R₉, R₁₀ and Ri are the same or different and each independently selected from the group consisting of hydrogen, methyl, ethyl and —NO₂;
R₁₂, R₁₃ and R₁₄ are the same or different and each independently selected from the group consisting of hydrogen, methyl, ethyl and —NO₂;
R₁₅ is selected from the group consisting of methyl, ethyl and cyclohexyl;
Ar₁ and Ar₂ are the same or different and each independently selected from the group consisting of phenyl, 2,6-dimethylphenyl, 2,6-diethylphenyl, 2,6-di(isopropyl)phenyl and 2,4,6-trimethylphenyl.

Accordingly, a few of the exemplary latent catalysts, which are within the scope of organo-ruthenium compounds of formula (II), without any limitation maybe selected from the group consisting of:

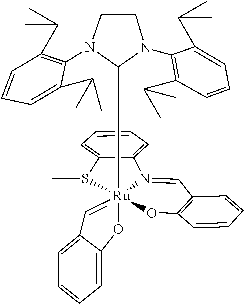

[1,3-bis(2,6-diisopropylphenyl)-2-imidazolidinylidene]{2-[(E)-({2-[methylthio-κS]phenyl}imino-κN)methyl]phenoxido-κO}[2-(oxido-κO)benzylidene-κC]ruthenium(II) (Ru-1);

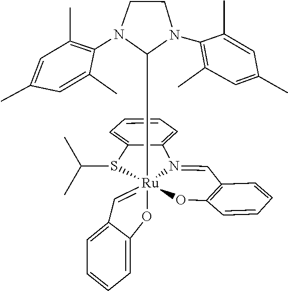

[1,3-bis(2,4,6-trimethylphenyl)-2-imidazolidinylidene]{2-[(E)-({2-[isopropylthio-κS]phenyl}imino-κN)methyl]phenoxido-κO}[2-(oxido-κO)benzylidene-κC]ruthenium(II) (Ru-2);

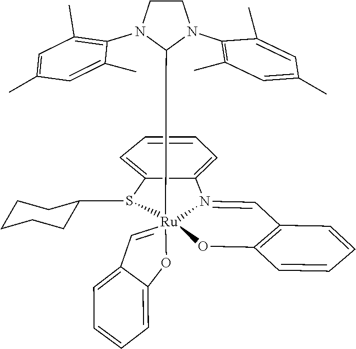

[1,3-Bis(2,4,6-trimethylphenyl)-2-imidazolidinylidene]{2-[(E)-({2-[cyclohexylthio-κS]phenyl}imino-κN)methyl]phenoxido-κO}[2-(oxido-κO)benzylidene-κC]ruthenium(II) (Ru-3); and

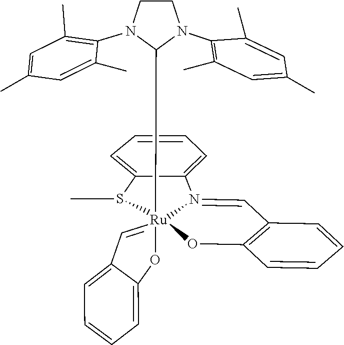

[1,3-bis(2,4,6-trimethylphenyl)-2-imidazolidinylidene]{2-[(E)-({2-[methylthio-κS]phenyl}imino-κN)methyl]phenoxido-κO}[2-(oxido-κO)benzylidene-κC]ruthenium(II) (Ru-4).

Interestingly, it has now been found that the organo-ruthenium compounds of formula (II) can be activated by certain of the known photoactive compounds (photosensitizer) when subjected to suitable photolytic conditions thereby facilitating mass polymerization of one or more monomers of the formulae (I) or (V) or (VI) contained in the composition of this invention under ROMP conditions as described herein.

The total amount of the organo-ruthenium compound is in the range from 0.001 wt % to 1 wt % based on the total amount of the chemical compound of formula (I). Preferably it is in the range from 0.005 to 0.5 wt %, more preferably from 0.01 to 0.1 wt %, even more preferably it is 0.02 to 0.05 wt %.

### Photosensitizer

According to the present invention, the composition contains a photosensitizer, preferably it is configured to bring the organo-ruthenium compound into its active form, preferably it is represented by formula (III).

As the photosensitizer, publicly known photoactive compounds, such as for example, a class of substituted xanthone derivatives, can be used for this purpose. Preferably the photosensitizer is illustrated by structural formula (III):

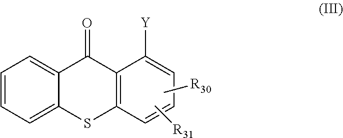

wherein
Y is halogen; and
R₃₀ and R₃₁ are the same or different and independently of each other selected from the group consisting of hydrogen, methyl, ethyl, linear or branched (C₃-C₁₂)alkyl, (C₃-C₁₂)cycloalkyl, (C₆-C₁₂)bicycloalkyl, (C₇-C₁₄)tricycloalkyl, (C₆-C₁₀)aryl, (C₆-C₁₀)aryl(C₁-C₃)alkyl, (C₁-C₁₂)alkoxy, (C₃-C₁₂)cycloalkoxy, (C₆-C₁₂)bicycloalkoxy, (C₇-C₁₄)tricycloalkoxy, (C₆-C₁₀)aryloxy(C₁-C₃)alkyl and (C₆-C₁₀)aryloxy.

In some embodiments, the compound of formula (III) is having the following:
Y is chlorine or bromine; and
R₃₀ and R₃₁ are the same or different and independently of each other selected from the group consisting of hydrogen, methyl, ethyl, n-propyl, iso-propyl, phenyl, cyclohexyl, methoxy, ethoxy, n-propoxy and phenoxy. Representative examples of the compounds of formula (VII), without any limitation, may be listed as follows:

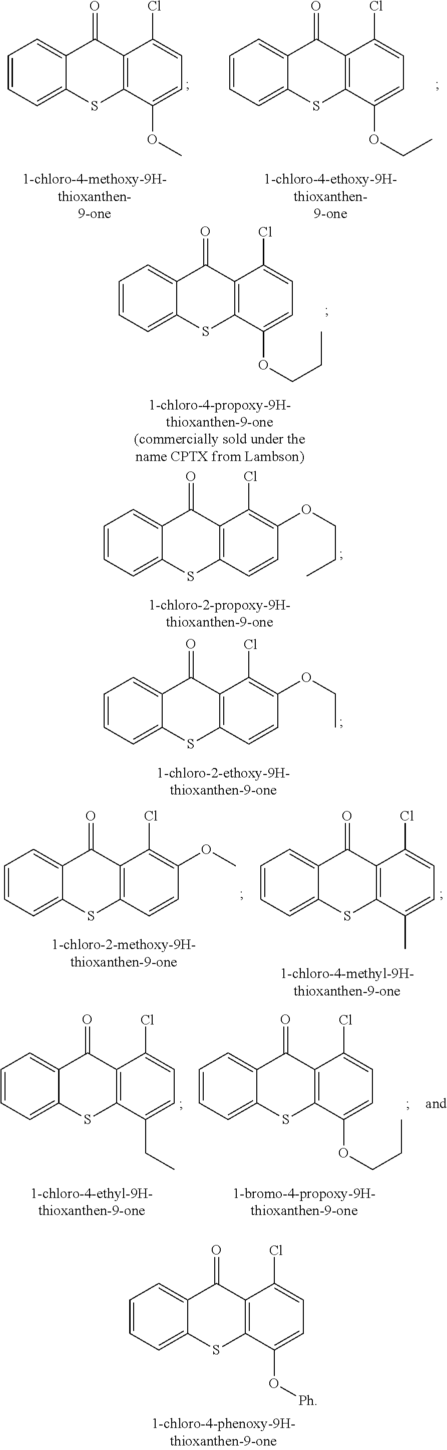

It is believed that employing a suitable combination of an organo-ruthenium compound, in combination with one or more of a photosensitizer (photosensitizer) can trigger the mass polymerization of the monomers when the composition is subjected to a suitable actinic radiation, generally at wavelengths of from about 240 nm to 410 nm, the composition undergoes mass ring open-metathesis polymerization (ROMP) to form a transparent film or an object. For that purpose, the combination of an organo-ruthenium compound of formula (II) and a photosensitizer of formula (III) is especially suitable.

Preferably, the total amount of the photosensitizer (preferably represented by formula (III)) is in the range from 0.01 to 5 wt % based on the total amount of the chemical compound of formula (I). More preferably it is from 0.05 to 1 wt %, even more preferably from 0.08 to 0.5 wt %.

In some embodiments the composition of this invention undergoes mass polymerization when exposed to suitable UV irradiation to form a substantially transparent film. The monomers undergo mass polymerization to form films which are substantially transparent to visible light. That is, most of the visible light is transmitted through the film. In some embodiments such film formed from the composition of this invention exhibits a transmission of equal to or higher than 90 percent of the visible light. In some other embodiments such film formed from the composition of this invention exhibits a transmission of equal to or higher than 95 percent of the visible light.

Accordingly, in some embodiments the compositions of this invention can be mass polymerized to form solid objects, such as transparent films, in less than five seconds after exposure to suitable actinic radiation. In some other embodiments the compositions of this invention can be mass polymerized to form solid objects, such as transparent films, in less than ten seconds after exposure to suitable actinic radiation. In yet some other embodiments the compositions of this invention can be mass polymerized to form solid objects, such as transparent films, in one to ten seconds after exposure to suitable actinic radiation; in two to nine seconds, in three to eight seconds, in four to seven seconds, and so on.

In yet other embodiments the composition of this invention undergoes mass polymerization when exposed to suitable UV irradiation at a temperature from 80° C. to 100° C. to form a substantially transparent film or an object.

In some embodiments the photosensitizer, preferably represented by formula (III), can be activated at certain wavelength of the electromagnetic radiation which can generally range from about 240 nm to 400 nm. Accordingly, any of the compounds which are active in this electromagnetic radiation can be employed in the compositions of this invention. In some embodiments the wavelength of the radiation to activate the photosensitizers, preferably represented by formula (III), is 260 nm. In some other embodiments the wavelength of the radiation to activate the photosensitizer is 310 nm. In yet some other embodiments the wavelength of the radiation to activate the photosensitizer is 395 nm.

However, any of the other known photosensitizers which can activate the latent organo-ruthenium compound employed herein can also be used in the composition of this invention. All such compounds are part of this invention.

### Chemical Compound of Formula (IV)

According to the present invention, the composition contains one or more of the chemical compounds of formula (IV):

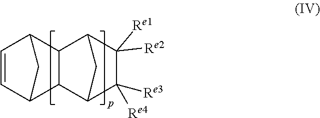

wherein
p is an integer 0, 1 or 2;
R^{e1}, R^{e2}, R^{e3} and R^{e4} are, each independently, selected from the group consisting of hydrogen, halogen, methyl, ethyl, linear (C₁-C₁₆)alkyl or branched (C₃-C₁₆)alkyl, perfluoro(C₁-C₁₂)alkyl, hydroxy(C₁-C₁₆)alkyl, (C₃-C₁₂)cycloalkyl, (C₆-C₁₂)bicycloalkyl, (C₇-C₁₄)tricycloalkyl, (C₆-C₁₀)aryl, (C₆-C₁₀)aryl(C₁-C₆)alkyl, perfluoro(C₆-C₁₀)aryl, perfluoro(C₆-C₁₀)aryl(C₁-C₆)alkyl, tri(C₁-C₆)alkoxysilyl, vinyl group, acrylate group, methacrylate group and an allyl group, linear (C₁-C₁₆)alkyl or branched (C₃-C₁₆)alkyl having a vinyl group, acrylate group, methacrylate group or an allyl group as the end group;
wherein at least one of R^{e1}, R^{e2}, R^{e3} and R^{e4} is a vinyl group, acrylate group, methacrylate group, an allyl group, linear (C₁-C₁₆)alkyl or branched (C₃-C₁₆)alkyl having a vinyl group, acrylate group, methacrylate group or an allyl group as the end group.

It is believed that the chemical compound of formula (IV) having at least one polymerizable group selected from vinyl group, acrylate group, methacrylate group, an allyl group or a combination of these may lead lower haze value of the compound and obtained film (layer).

According to the present invention, as the chemical compounds of formula (IV), any publicly available chemical compounds falls within the formula (IV) can be used.

In a preferred embodiment of the present invention, from the view point of lowering haze value of the film (layer), the monomer of formula (IV) is selected from the group consisting of:

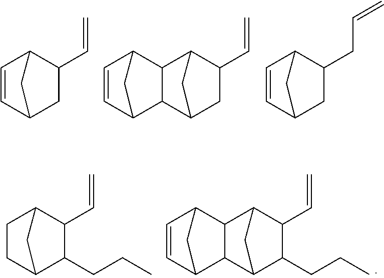

The most preferably, the composition contains at least vinyl norbornene as the monomer of formula (IV).

In a preferable embodiment of the present invention, the total amount of the chemical compounds of formula (IV) is in the range from 0.1 to 100 wt % based on the total amount of the compound of formula (I). More preferably, from the view point of achieving good lower haze value of the film (layer), and/or realizing good optical and mechanical properties of the film, it is in the range from 1 to 50 wt %. More preferably from 5 to 30 wt %, even more preferably from 8 to 20 wt %.

### Additional Monomers (V), (VI)

According to the present invention, the compositions of this invention may optionally contain additional monomers. In some embodiments, the composition of the present invention may further contain one or more monomers selected from monomers of formula (V) and/or the monomers of formula (VI).

The monomer of formula (V) is:

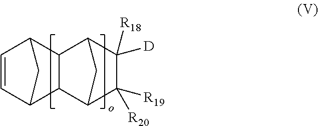

wherein:
o is an integer from 0 to 2, inclusive;
D is SiR₂₁R₂₂R₂₃ or a group selected from: —(CH₂)_{c}—O—SiR₂₁R₂₂R₂₃ (E); —(CH₂)_{c}—SiR₂₁R₂₂R₂₃ (F); and
—(SiR₂₁R₂₂)_{c}—O—SiR₂₁R₂₂R₂₃ (G); wherein
c is an integer from 1 to 10, inclusive, and where one or more of CH₂ is optionally substituted with (C₁-C₁₀)alkyl, (C₁-C₁₀)perfluoroalkyl or (C₆-C₁₄)aryl;
R₁₈, R₁₉ and R₂₀ are the same or different and independently of each other selected from hydrogen, halogen and hydrocarbyl, where hydrocarbyl is selected from methyl, ethyl, linear or branched (C₃-C₁₂)alkyl, (C₃-C₁₂)cycloalkyl, (C₆-C₁₂)bicycloalkyl, (C₇-C₁₄)tricycloalkyl, (C₆-C₁₀)aryl, (C₆-C₁₀)aryl(C₁-C₃)alkyl, (C₁-C₁₂)alkoxy, (C₃-C₁₂)cycloalkoxy, (C₆-C₁₂)bicycloalkoxy, (C₇-C₁₄)tricycloalkoxy, (C₆-C₁₀)aryloxy(C₁-C₃)alkyl or (C₆-C₁₀)aryloxy; and
R₂₁, R₂₂ and R₂₃ are each independently of one another methyl, ethyl, linear or branched (C₃-C₉)alkyl, substituted or unsubstituted (C₆-C₁₄)aryl, methoxy, ethoxy, linear or branched (C₃-C₉)alkoxy or substituted or unsubstituted (C₆-C₁₄)aryloxy.

In this aspect of the invention, it has now been found that monomers of formula (V) provides further advantages. Namely, the monomers of formula (V) depending upon the nature of the monomer may impart high or low refractive index to the composition, low or high dielectric constant, thus it can be tailored to meet the need. In addition, the monomers of formula (V) generally improve the adhesion properties and thus can be used as “adhesion modifiers.” Finally, the monomers of formula (V) may exhibit low viscosity and good solubility for the latent catalyst and/or activator, among various other advantages.

In some embodiments, the composition of this invention contains first and second monomer of formula (I) distinct from each other and one of said first and second monomers having a refractive index of at least 1.5 and viscosity below 100 centipoise, and wherein said first monomer is completely miscible with said second monomer to form a clear solution. However, as noted, any one or more of monomers of formula (V) can also be used in this embodiment of the invention.

The monomer of formula (VI) is:

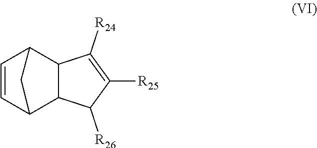

wherein
R₂₄ and R₂₅ are the same or different and each independently selected from the group consisting of hydrogen, methyl, ethyl, linear or branched (C₃-C₆)alkyl, methoxy, ethoxy, linear or branched (C₃-C₆)alkyloxy, acetoxy, (C₂-C₆)acyl, phenyl and phenoxy; or
R₂₄ taken together with R₂₅ and the carbon atoms to which they are attached to form a (C₅-C₇)carbocyclic ring optionally containing one or more double bonds;
R₂₆ is hydrogen, halogen, methyl, ethyl, linear or branched (C₃-C₁₆)alkyl, (C₆-C₁₀)aryl, (C₆-C₁₀)aryl(C₁-C₆)alkyl, hydroxy, methoxy, ethoxy, linear or branched (C₃-C₁₆)alkoxy, (C₆-C₁₀)aryloxy,
(C₆-C₁₀)aryl(C₁-C₆)alkoxy, —O(CO)R₂₇ and —O(CO)OR₂₇, where R₂₇ is methyl, ethyl, linear or branched (C₃-C₁₆)alkyl, (C₆-C₁₀)aryl and (C₆-C₁₀)aryl(C₁-C₆)alkyl.

Similarly, any of the monomers within the scope of monomer of formula (V) can be employed in the composition of this invention. Representative examples of monomer of formula (V) include the following without any limitations:

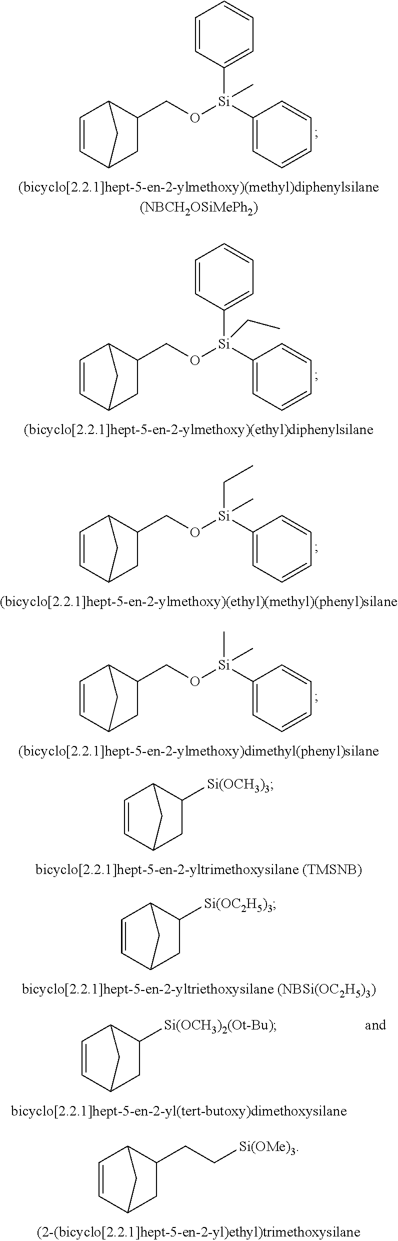

Representative examples of monomer of formula (VI) include the following without any limitations:

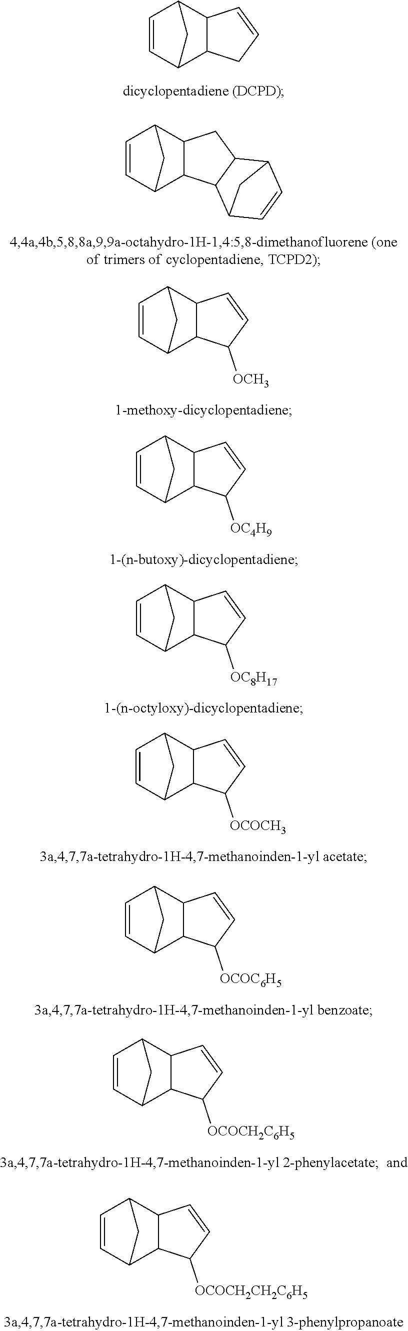

### Ultraviolet (UV) Light Blockers

It is believed that incorporation of certain ultraviolet (UV) light blockers imparts surprisingly further stability to the composition of this invention especially when used in the surroundings of UV exposure, such as for example, in a vat of the 3D printer or in the encapsulation of an optical device (e.g. OLED). Even more importantly, it has now been found that incorporation of two or more such UV blocking compounds further provides synergistic effect in that the compositions of this invention can be cured at similar or faster speeds when compared with compositions not employing such two or more UV blocking compounds. It is surprising to note that the incorporation of these two or more UV blockers do not decrease the mass polymerization activity of the compositions of this invention when exposed to suitable actinic radiation, thus providing a synergistic and beneficial effect.

It should further be noted that the compositions of this invention undergo mass polymerization at a rate similar to those of the compositions containing neither one of the two UV blockers when exposed to suitable actinic radiation. Similarly, the composition of this invention exhibits similar rate of polymerization when compared with a composition containing only one of the UV blockers. Thus, there is no discernable decrease in activity of the rate of polymerization of the compositions of this invention when subjected to suitable actinic radiation. Furthermore, the films formed from the compositions of this invention exhibit substantially same percent transmission, where a composition of this invention is shown to exhibit better than 90% transmission at wavelengths from 370 nm to 800 nm.

Accordingly, the composition of this invention contains at least one compound of formula (VIII):

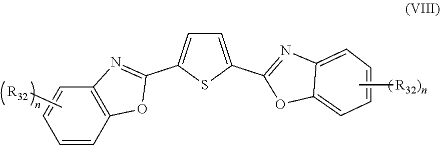

wherein
n is an integer from 0 to 4;
each R₃₂ is independently selected from the group consisting of hydrogen, methyl, ethyl, linear or branched (C₃-C₁₂)alkyl, (C₃-C₁₂)cycloalkyl, (C₆-C₁₂)bicycloalkyl, (C₇-C₁₄)tricycloalkyl, (C₆-C₁₀)aryl, (C₆-C₁₀)aryl(C₁-C₃)alkyl, (C₁-C₁₂)alkoxy, (C₃-C₁₂)cycloalkoxy, (C₆-C₁₂)bicycloalkoxy, (C₇-C₁₄)tricycloalkoxy, (C₆-C₁₀)aryloxy(C₁-C₃)alkyl and (C₆-C₁₀)aryloxy.

In addition, the composition of this invention contains at least one compound of formula (IX):

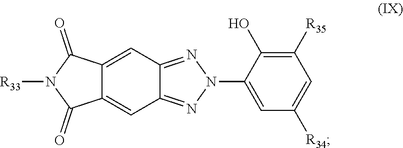

wherein
R₃₃ is selected from the group consisting of methyl, ethyl, linear or branched (C₃-C₁₂)alkyl and (C₃-C₁₂)cycloalkyl.

Each of R₃₄ and R₃₅ may be the same or different and independently selected from the group consisting of (C₁-C₁₀)alkyl, (C₆-C₁₈)aryl, (C₆-C₁₂)aryl(C₁-C₅)alkyl, and (C₁-C₅)alkyl(C₆-C₁₂)aryl. In some embodiments, R₃₄ and R₃₅ is independently selected from the group consisting of (C₄-C₈)alkyl, phenyl, and phenyl(C₁-C₃)alkyl. In some other embodiments, R₃₄ and R₃₅ is independently selected from the group consisting of (C₅-C₈)alkyl, and phenyl(C₁-C₃)alkyl.

Alkyl portion of R₃₄ and R₃₅ can be linear or branched. Again, in each occurrence independently selected in whole or part of such alkyl portion being branched. Optionally one or more of methylene of alkyl portion of R₃₄ and R₃₅ can be replaced with —CO—, —O—, or —COO—. That is, —CH₂— portion of alkyl is replaced with one of —CO—, —O—, or —COO—. In some embodiments one or more of hydrogens on methylene portion of R₃₄ and/or R₃₅ is replaced with —COO—.

By inclusion of a compound of formula (VIII) and a compound of formula (IX), surprisingly, it is now possible to not only improve the stability of the composition but also improve the optical performance of the articles made therefrom either in fabricating an OLED device or in the fabrication of an 3D article. It is believed that the compounds of formulae (VIII) or (IX) function as UV blockers, among other functions, thereby imparting greater stability to the composition while in peripheral contact with any UV light during the UV exposure of the composition, for example when the composition is drawn out of the vat for forming the intended 3D objects.

Therefore, any of the compounds which may function similarly to that of compounds of formulae (VIII) or (IX) can also be employed in the composition of this invention, such as for example, any of the other known UV blockers. Any of the amounts of a compound of formulae (VIII) or (IX) that would bring about the desired benefit can be employed in the composition of this invention. Generally, such amounts may vary from about 1:200 molar parts of a compound of formulae (VIII) or (IX):a compound of formula (II). In some other embodiments such amounts are from about 1:100 molar parts of a compound of formulae (VIII) or (IX):a compound of formula (II); or 1:50 molar parts of a compound of formulae (VIII) or (IX):a compound of formula (II), and so on. It should be noted however that it is not necessary to employ same amounts of compounds of formulae (VIII) or (IX), but varied amounts of compounds of formula (VIII) in combination with suitable amount of compound of formula (IX) can be employed, generally in the amounts as described hereinabove.

Representative examples of the compounds of formula (VIII), without any limitation, may be listed as follows:

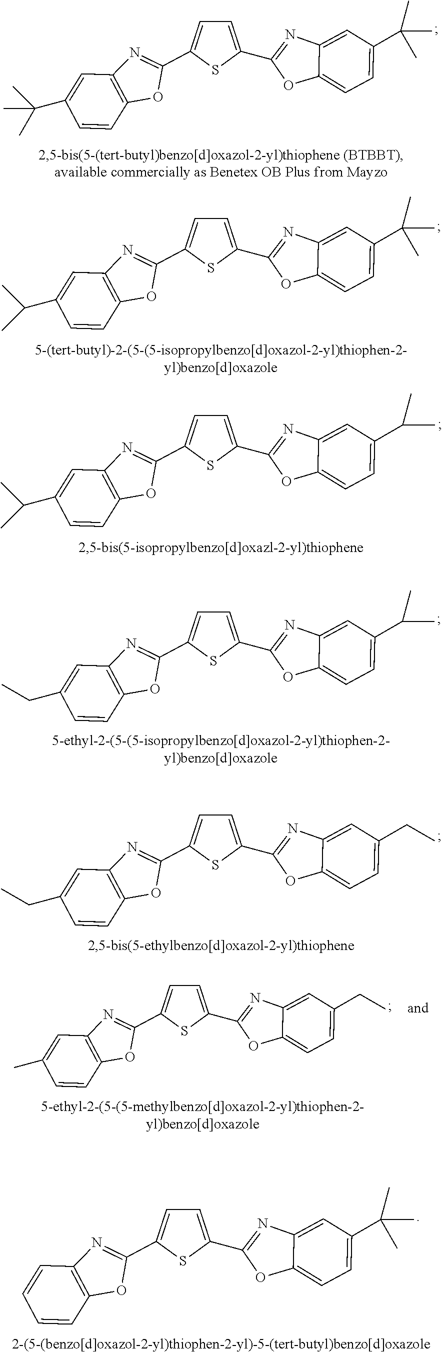

Representative examples of the compounds of formula (IX), without any limitation, may be listed as follows:

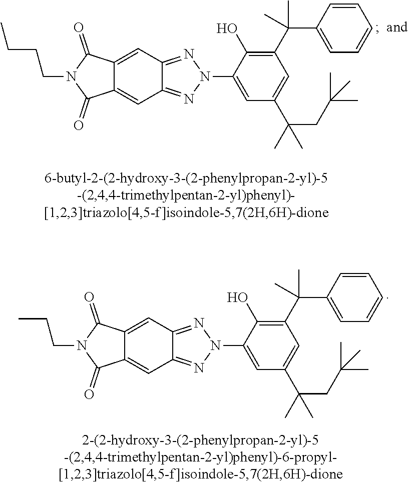 [SMILES: CCCCN1C(=O)c2cc3nn(-c4cc(C(C)(C)CC(C)(C)C)cc(C(C)(C)c5ccccc5)c4O)nc3cc2C1=O ; CCCN1C(=O)c2cc3nn(-c4cc(C(C)(C)CC(C)(C)C)cc(C(C)(C)c5ccccc5)c4O)nc3cc2C1=O]

Various other UV light blocking compounds and/or UV light absorbers that can be used in the composition of this invention include the following:

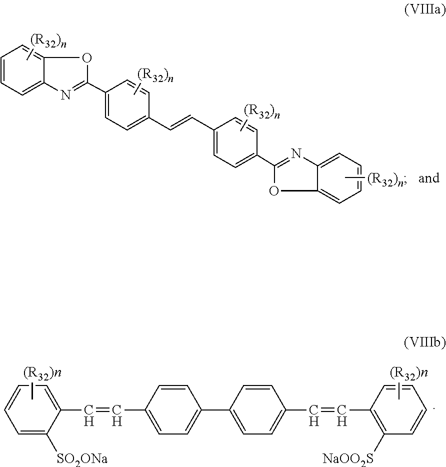

Wherein n and R₃₂ are same as defined on formula (VIII).

Representative compounds within the scope of compounds of formulae (VIIIa) and (VIIIb) may be represented as follows:

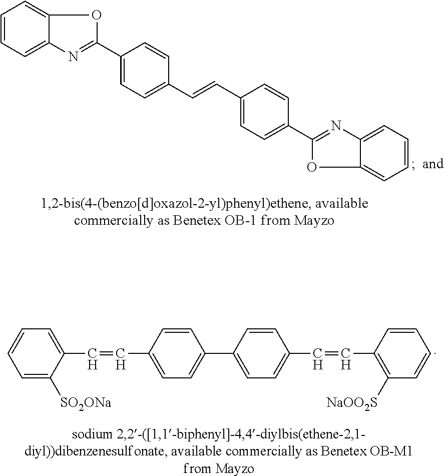

As used herein the Aryl may further include the following:
substituted or unsubstituted biphenyl of formula:

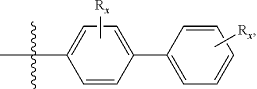

substituted or unsubstituted naphthyl of formula:

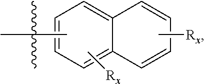

substituted or unsubstituted terphenyl of formula:

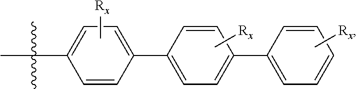

substituted or unsubstituted anthracenyl of formula:

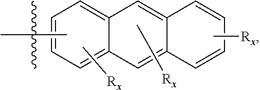

substituted or unsubstituted fluorenyl of formula:

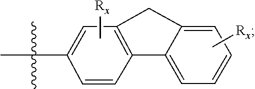

where Rₓ in each occurrence is independently selected from methyl, ethyl, linear or branched (C₃-C₁₂)alkyl or (C₆-C₁₀)aryl.

### Monomeric Crosslinking Agents

Advantageously it has now been further found that employing one or more monomeric crosslinking agents in suitable quantities can dramatically enhance the mechanical properties of the resulting three dimensional objects formed from the compositions of this invention. Representative examples of such suitable monomeric crosslinkers can be selected from the group consisting of:
i) a compound of formula (Xa):

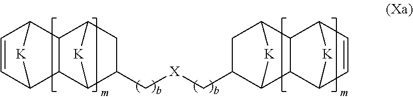

ii) a compound of formula (Xb):

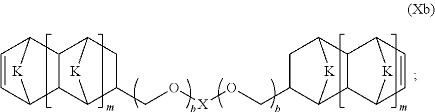

iii) a compound of formula (Xc):

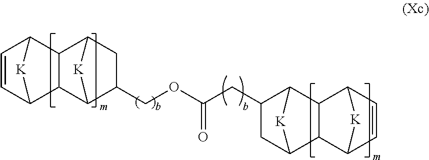

where
m is an integer 0, 1 or 2;
b is an integer from 1 to 10;
K is selected from the group consisting of CH₂, CH₂—CH₂, O and S; X is a bond or a moiety selected from the group consisting of O, S, NRₐ, SiR_{b}R_{c}, SiR_{b}R_{c}O(SiR_{b}R_{c}O)ₙSiR_{b}R_{c}, SiR_{b}R_{c}(C₆-C₁₀)arylSiR_{b}R_{c}, —C(O)—, —C(O)O—,
—OC(O)—, —OC(O)—O—, —S—C(O)—, —C(O)—S—, —CH═CH— and —C≡C—;
Rₐ, R_{b} and R_{c} are independently of each other selected from the group consisting of hydrogen, methyl, ethyl or a linear or branched (C₃-C₁₂)alkyl, (C₃-C₈)cycloalkyl, (C₅-C₁₂)bicycloalkyl, (C₅-C₁₂)bicycloalkenyl and (C₅-C₁₂)bicycloalkenyl(C₁-C₃)alkylSi(CH₃)₂, and such that O, NRₐ and/or S atoms are not linked directly to one another; and
n is an integer from 0 to 10.

Advantageously, it has now been found that incorporating one or more compounds of formulae (Xa), (Xb) or (Xc) it is possible to tailor the properties of the compositions for the intended purpose. For example, suitable combination of one or more compounds of formulae (Xa), (Xb) or (Xc) with the composition of this invention it is now possible to improve the mechanical properties of the articles formed from the composition of this invention among other properties. More particularly it has now been found that incorporation of certain siloxane compounds within the scope of compounds of formulae (Xa) or (Xb) improves the impact strength of the products formed therefrom. Any amount of one or more compounds of formula (Xa), (Xb) or (Xc) can be employed that would bring about the intended benefit. In general such amounts may range from 0 to 20 mole percent of one or more compounds of formulae (Xa), (Xb) or (Xc) based upon the total moles of monomers of formula (I), in combination with one or more monomers of formulae (V) or (VI), if employed, and one or more compounds of formulae (Xa), (Xb) or (Xc). In some embodiments such amounts may range from 1 to 15 mole percent, and in some other embodiments such amounts may range from 0.5 to 10 mole percent, and yet in some other embodiments such amounts may range from 0.5 to 5 mole percent.

Accordingly, in some embodiments the impact strength of the polymers formed from the composition of this invention is at least 40 J/m. In some other embodiments the impact strength of the polymers formed from the composition of this invention is at least 60 J/m. In yet some other embodiments the impact strength of the polymers formed from the composition of this invention is at least 80 J/m, 100 J/m or higher, 140 J/m or higher or it can be higher than 160 J/m, such as for example higher than 170 J/m, higher than 180 J/m, higher than 200, 220 or 240 J/m, or even higher than 500, 550, 600, 700 or 800 J/m depending upon the types of monomers employed as described herein. In some embodiments the polymers formed from the composition of this invention comprising one or more monomers of formula (I) itself may exhibit such unusual impact strength which can range from 50 to 800 J/m.

In some embodiments the compounds of formulae (Xa), (Xb) or (Xc) are each having m=0 and K═CH₂. In some embodiments the compounds of formulae (Xa), (Xb) or (Xc) are each having m=1 and K═CH₂. In yet some other embodiments the compounds of formulae (Xa), (Xb) or (Xc) are each having m=2 and K═CH₂.

Representative examples of compounds within the scope of formulae (Xa) or (Xb) without any limitation includes the following:

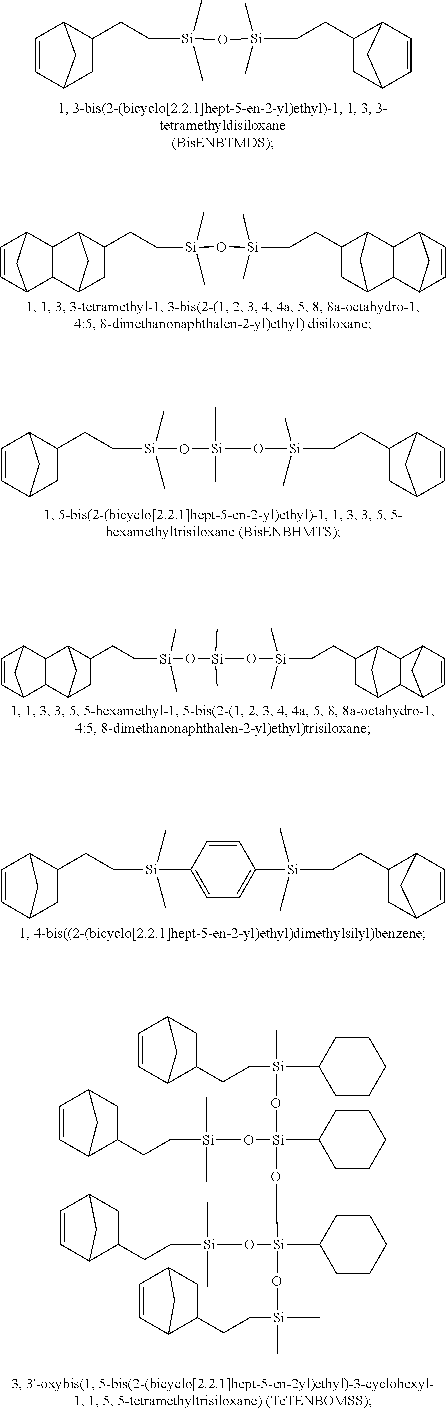 [SMILES: C[Si](C)(CCC1CC2C=CC1C2)O[Si](C)(C)CCC1CC2C=CC1C2 ; C[Si](C)(CCC1CC2CC1C1C3C=CC(C3)C21)O[Si](C)(C)CCC1CC2CC1C1C3C=CC(C3)C21 ; C[Si](C)(CCC1CC2C=CC1C2)O[Si](C)(C)O[Si](C)(C)CCC1CC2C=CC1C2 ; C[Si](C)(CCC1CC2CC1C1C3C=CC(C3)C21)O[Si](C)(C)O[Si](C)(C)CCC1CC2CC1C1C3C=CC(C3)C21 ; C[Si](C)(CCC1CC2C=CC1C2)c1ccc([Si](C)(C)CCC2CC3C=CC2C3)cc1 ; C[Si](C)(CCC1CC2C=CC1C2)O[Si](O[Si](C)(C)CCC1CC2C=CC1C2)(O[Si](O[Si](C)(C)CCC1CC2C=CC1C2)(O[Si](C)(CCC1CC2C=CC1C2)C1CCCCC1)C1CCCCC1)C1CCCCC1]

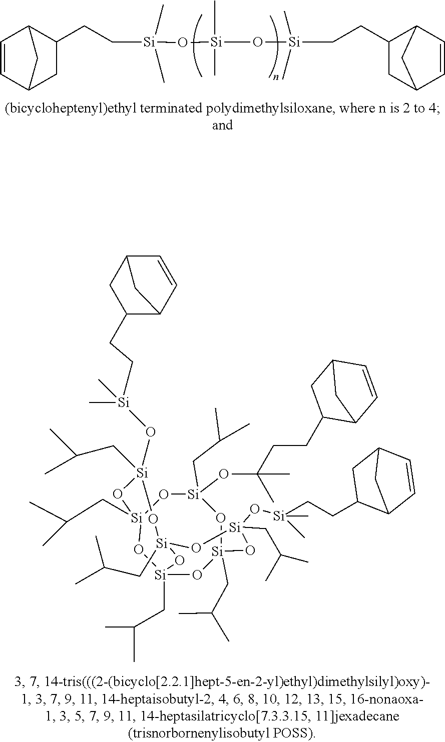

In addition, various other oligomeric or polymeric polysiloxanes with multi-functional cycloolefinic pendent groups are suitable as crosslinking molecules in the composition of this invention which may or may not be within the scope of compound of formula (XIa). Such examples include an oligomeric siloxane of the formula:

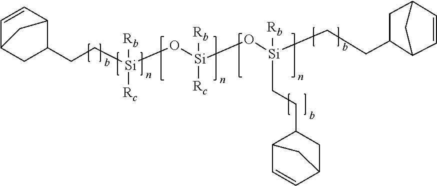

Where b is an integer from 1 to 9,
n is an integer from 1 to 10; and
R_{b} and R_{c} are independently selected from the group consisting of methyl, ethyl, n-propyl, iso-propyl, n-butyl, isobutyl and phenyl.

Various other non-limiting examples of the compounds of formulae (Xa), (Xb) or (Xc) maybe selected from the group consisting of:

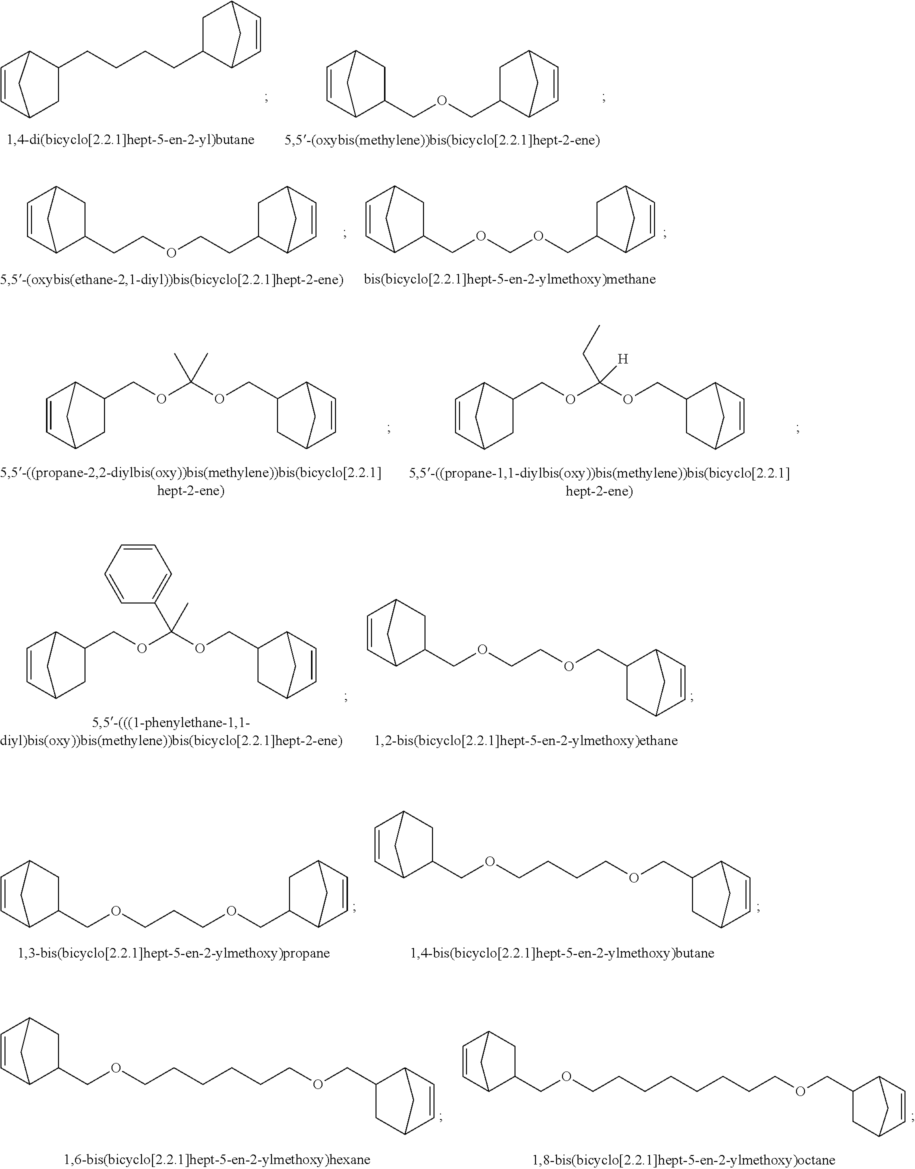

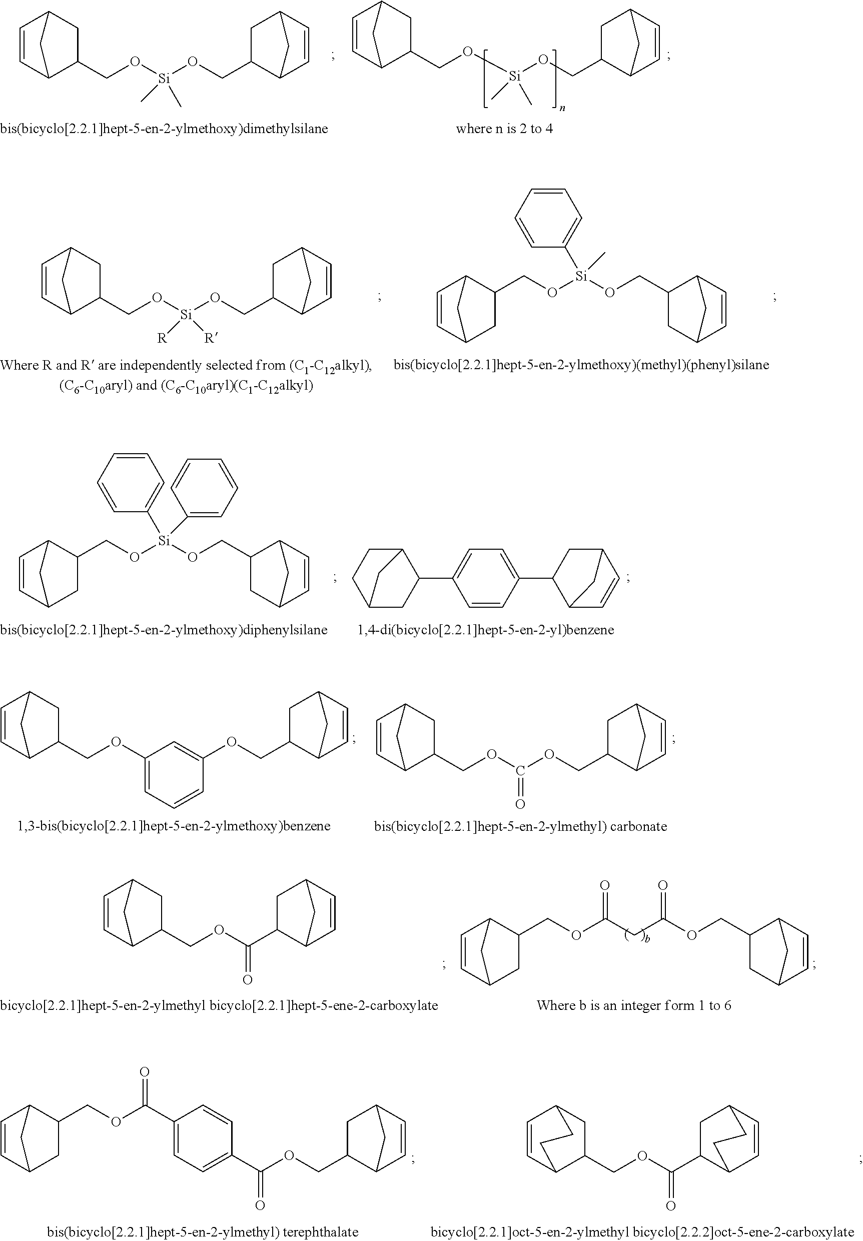

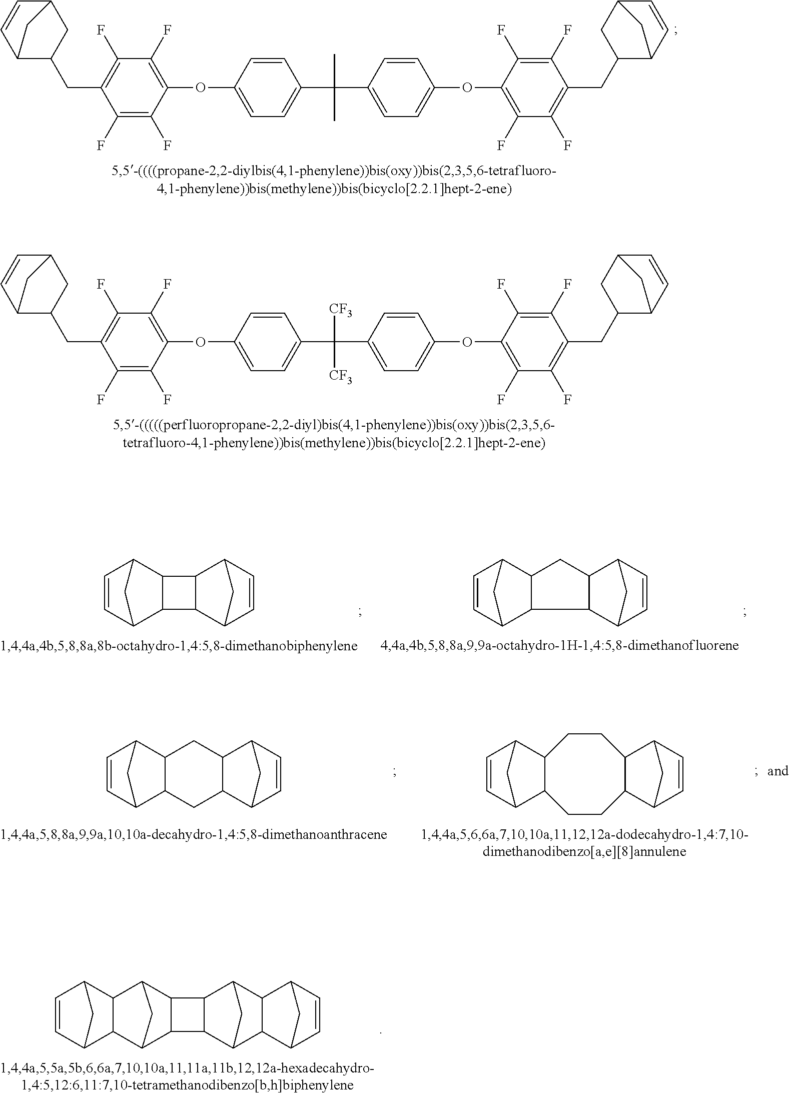

Various other non-limiting examples within the scope of the compounds of formula (Xa), (Xb) or (Xc) maybe enumerated as follows:

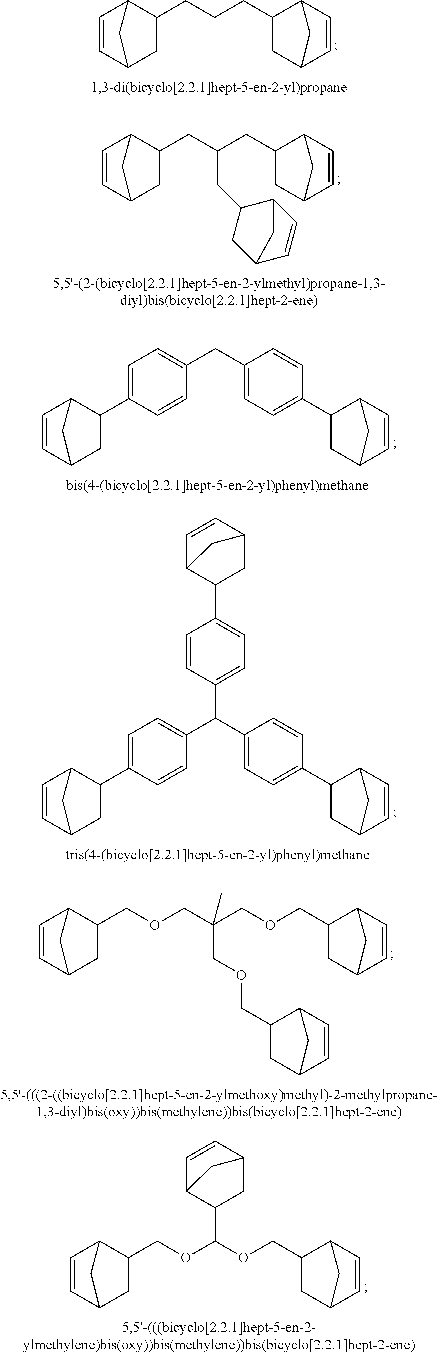

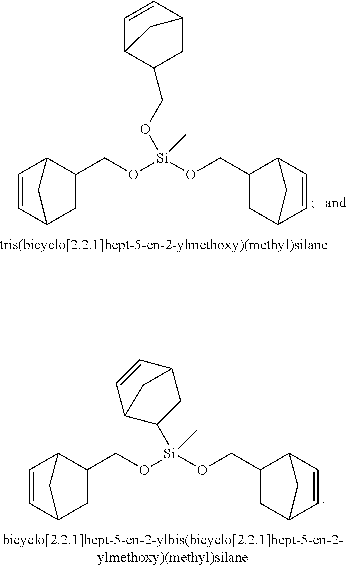 [SMILES: C[Si](OCC1CC2C=CC1C2)(OCC1CC2C=CC1C2)OCC1CC2C=CC1C2 ; C[Si](OCC1CC2C=CC1C2)(OCC1CC2C=CC1C2)C1CC2C=CC1C2]

In some embodiments of this invention the composition of this invention may additionally contain other photosensitizer compounds which can activate the organo-ruthenium compounds of formulae (II) in order to facilitate the mass polymerization of the monomers of formula (I) and/or monomers of formulae (V) or (VI), if present. For this purpose, any suitable sensitizer compound can be employed in the compositions of the present invention. Such suitable sensitizer compounds include, photosensitizers, such as, anthracenes, phenanthrenes, chrysenes, benzpyrenes, fluoranthenes, rubrenes, pyrenes, xanthones, indanthrenes, and mixtures thereof.

In some exemplary embodiments, suitable sensitizer components include mixtures thereof. Generally, the photosensitizers absorb energy from the radiated light source and transfers that energy to the desirable substrate/reactant employed in the composition of this invention.

The compositions in accordance with the present invention may further contain optional additives as may be useful for the purpose of improving properties of both the composition and the resulting object made therefrom. Such optional additives for example may include anti-oxidants and synergists, and the like.

In another aspect, the present invention further relates to a method for fabricating a film comprising steps of,
(X^{a1}) providing a composition of any one of claim 1 to 10 onto a substrate, a layer, or an outermost surface of an device to obtain a coated layer,
(X^{a2}) irradiating the coated layer with light (applying light irradiation) to form a cured film, preferably with light having peak maximum wavelength in the range from 360 to 430 nm, preferably the dose of the light irradiated to the composition is in the range from 1 to 5 J/cm².

In another aspect of this embodiment of this invention the composition of this invention undergoes mass polymerization when subjected to suitable radiation for a sufficient length of time to form a polymeric film or a solid object.

That is to say that the composition of this invention is poured onto a surface or onto a substrate which needs to be encapsulated, and exposed to suitable radiation in order for the monomers to undergo polymerization to form a solid transparent polymer which could be in the form of a transparent film or a solid object.

Generally, as already noted above, such polymerization can take place when exposed to actinic radiation at wavelengths ranging from about 240 nm to 410 nm. The compositions can also be subjected simultaneously to suitable radiation and heat to cause mass polymerization. By practice of this invention it is now possible to obtain polymeric films on such substrates which are substantially transparent film or solid objects depending on the method of fabrication employed.

The “substantially transparent film” as used herein means that the films formed from the composition of this invention are optically clear in the visible light. Accordingly, in some embodiments of this invention such films are having at least 90 percent of visible light transmission, in some other embodiments the films formed from the composition of this invention exhibit at least 95 percent of visible light transmission.

The coating of the desired substrate to form a film with the composition of this invention can be performed by any of the coating or printing procedures as described herein and/or known to one skilled in the art, such as by spin coating. Other suitable coating methods include without any limitation spraying, doctor blading, meniscus coating, ink jet coating and slot coating. The composition can also be inkjet printed onto the substrate as is known in the art. The mixture can also be poured onto a substrate to form a film. Suitable substrate includes any appropriate substrate as is, or may be used for electrical, electronic or optoelectronic devices, for example, a semiconductor substrate, a ceramic substrate, a glass substrate.

Next, the coated substrate is exposed to suitable actinic radiation, i.e., exposed to radiation of wavelength ranging from 240 nm to 410 nm as described herein to facilitate the mass polymerization. In some embodiments the substrate is exposed to radiation and baked at a temperature of from about 40° C. to about 90° C. for about 2 minutes to 30 minutes. In some other embodiments the substrate is exposed to radiation and baked at a temperature of from about 60° C. to about 90° C. for 5 minutes to 20 minutes.

The films thus formed are then evaluated for their optical properties using any of the methods known in the art. For example, the refractive index of the film across the visible spectrum can be measured by ellipsometry. The optical quality of the film can be determined by visual observation. Quantitatively the percent transparency can be measured by visible spectroscopy. Generally, the films formed according to this invention exhibit excellent optical transparent properties and can be tailored to desirable refractive index as described herein.

The compositions of this invention are also useful as protective layers in a variety of electronic or optoelectronic devices, particularly organic electronic devices, which are sensitive to environmental conditions, especially to oxygen and moisture. The compositions of this invention serve as such protective layers providing much needed protection against environmental conditions. Generally, in such applications, for example, an organic light emitting diode (OLED) devices, a plurality of layers of OLED or an OLED stack is formed on a suitable substrate, which is then encapsulated by the compositions of this invention.

The encapsulation of the OLED stack can be carried out by any of the known methods including but not limited to dip coating, inkjet coating, spin coating, and the like methods. Then the coated OLED stack is subjected to suitable actinic radiation so as to form a transparent polymeric layer on the OLED stack via ROMP. Before or after the transparent polymeric layer formation, a conducting layer is deposited on to the polymeric layer. Such conducting layers can be deposited by any of the known methods, such as for example, chemical vapor deposition (CVD) methods, among others. The polymeric layers formed from the compositions of this invention are stable to such CVD methods and retain their properties especially the transparent property, among other properties as described herein. Finally, the OLED device may optionally be protected by forming another polymeric layer by coating with the composition of this invention as described above and subjecting to suitable actinic radiation. Such stacking process can take plural processes of the transparent polymeric layer formation and/or the conducting layer deposition.

In another aspect, the present invention further relates to a film formed from the composition of the present invention.

In another aspect, the present invention further relates to a film obtained or obtainable by the method of the present invention.

Preferably, said film is optically transparent.

In a preferable embodiment of the present invention, the film has the layer thickness in the range from 0.1 to 100 μm, preferably from 1 to 20 μm, more preferably from 5 to 10.

In a preferable embodiment of the present invention, the film has the relative permittivity value εᵣ<2.5, preferably 1.5≤ᵣ<2.5, more preferably 2.0≤εᵣ≤2.4.

In a preferable embodiment of the present invention, the film has haze value 46 or less. Preferably 20 or less, more preferably 3 or less.

Preferably it is 0 or more.

According to the present invention, said Haze value is measured at room temperature in air following the procedure described in ASTM D1003-21. The measurement can be performed using a commercial haze meter like e.g. the BYK Gardner Haze-Gard plus 4725.

In another aspect, the present invention further relates to a device comprising at least the film of the present invention. Preferably said device is an optical device, more preferably said device is a display device, preferably said device further comprises a functional module, more preferably said device comprises a functional module selected from OLED, LCD and μLED.

In another aspect, the present invention also relates to use of a chemical compound of formula (IV) in a photo curable composition for forming a protection layer of an device:

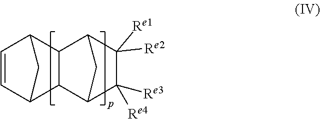

wherein
p is an integer 0, 1 or 2;
R^{e1}, R^{e2}, R^{e3} and R^{e4} are, each independently, selected from the group consisting of hydrogen, halogen, methyl, ethyl, linear (C₁-C₁₆)alkyl or branched (C₃-C₁₆)alkyl, perfluoro(C₁-C₁₂)alkyl, hydroxy(C₁-C₁₆)alkyl, (C₃-C₁₂)cycloalkyl, (C₆-C₁₂)bicycloalkyl, (C₇-C₁₄)tricycloalkyl, (C₆-C₁₀)aryl, (C₆-C₁₀)aryl(C₁-C₆)alkyl, perfluoro(C₆-C₁₀)aryl, perfluoro(C₆-C₁₀)aryl(C₁-C₆)alkyl, tri(C₁-C₆)alkoxysilyl, vinyl group, acrylate group, methacrylate group and an allyl group, linear (C₁-C₁₆)alkyl or branched (C₃-C₁₆)alkyl having a vinyl group, acrylate group, methacrylate group or an allyl group as the end group;
wherein at least one of R^{e1}, R^{e2}, R^{e3} and R^{e4} is a vinyl group, acrylate group, methacrylate group, an allyl group, linear (C₁-C₁₆)alkyl or branched (C₃-C₁₆)alkyl having a vinyl group, acrylate group, methacrylate group or an allyl group as the end group.

More details of the chemical compound of formula (IV) is described in the section of Chemical compound of formula (IV) above.

### Technical Effects of the Invention

Present invention provides one or more of the following effects: higher transparency of the composition and/or an obtained film at visible light wavelength, lower haze value of an obtained film, lower dielectric constant of a composition and an obtained film, lower permittivity of a composition and an obtained film, improved touch sensitivity of a touch-screen separated from an OLED device by a film according to this invention, high refractive index, good mechanical properties of an obtained film against mechanical stress such as folding and bending, good curing ratio of an composition, good thermal properties.

The working examples below provide descriptions of the present invention, as well as an in-detail description of their fabrication. However, the present invention is not limited to the working examples.

### Working Examples

The following abbreviations have been used hereinbefore and hereafter in describing some of the compounds, instruments and/or methods employed to illustrate certain of the embodiments of this invention:
HexylTD: 2-hexyl-1,2,3,4,4a,5,8,8a-octahydro-1,4:5,8-dimethanonaphthalene;
PETD: 2-phenethyl-1,2,3,4,4a,5,8,8a-octahydro-1,4:5,8-dimethanonaphthalene
CL1: 1,3-bis(2-(bicyclo[2.2.1]hept-5-en-2-yl)ethyl)-1,1,3,3-tetramethyldisiloxane

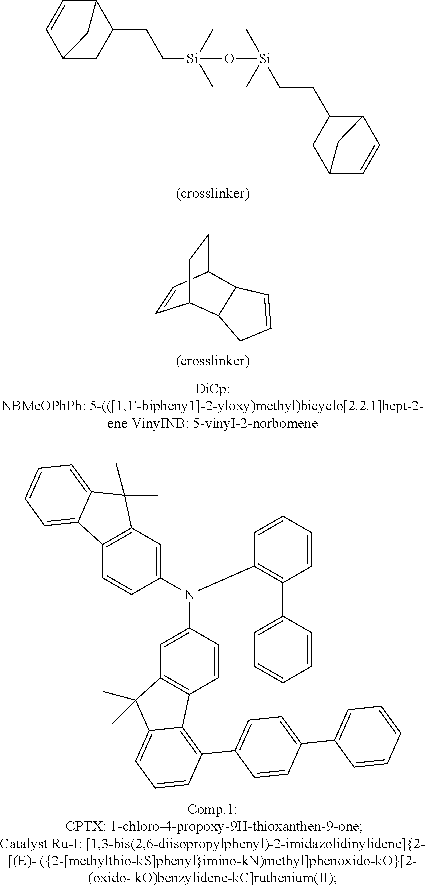 [SMILES: C[Si](C)(CCC1CC2C=CC1C2)O[Si](C)(C)CCC1CC2C=CC1C2 ; C1=CC2C3C=CC(CC3)C2C1 ; CC1(C)c2ccccc2-c2ccc(N(c3ccc4c(c3)C(C)(C)c3cccc(-c5ccc(-c6ccccc6)cc5)c3-4)c3ccccc3-c3ccccc3)cc21]

Various monomers as used herein are either commercially available or can be readily prepared following the procedures as described in U.S. Pat. No. 9,944,818.

### Comparative Example 1: Composition Preparation

In glass brown bottles, CPTX (0.1 wt. %) is dissolved in HexylTD (99.87 wt %) via sonication at 30° C. for 20 minutes to form a clear solution. The solution is purged with nitrogen for 8 hours. Ru-1 catalyst (0.03 wt %) is added in a glove box to the purged solution and sonicated for 30 minutes to completely dissolve the catalyst. The sample is checked optically for full dissolution and filtered prior to further experiments. Then comparative sample (sample 0) is obtained.

### Working Examples 1 to 10: Composition Preparations

The samples 1 to 10 (working examples 1 to 10) are obtained in the same manner as described in comparative example 1 above except for that the following materials as mentioned in table 1 are used instead of the materials used in comparative example 1.

TABLE 1

| | | Composition (in weight %) | | | | | | | | |
|---|---|---|---|---|---|---|---|---|---|---|
| | Sample | | | | | | | | | Catalyst |
| Examples | No. | HexylTD | PETD | CL1 | DiCp | (NBMeOPhPh) | VinylNB | Comp. 1 | CPTX | Ru-I |
| Comparative | 0 | 99.87 | | | | | | | 0.1 | 0.03 |
| example 1 | | | | | | | | | | |
| Working | 1 | 89.87 | | | | | 10 | | 0.1 | 0.03 |
| example 1 | | | | | | | | | | |
| Working | 2 | 84.87 | | | | | 15 | | 0.1 | 0.03 |
| example 2 | | | | | | | | | | |
| Working | 3 | 85.87 | | | | | 10 | 4 | 0.1 | 0.03 |
| example 3 | | | | | | | | | | |
| Working | 4 | 79.87 | | 5 | 5 | | 10 | | 0.1 | 0.03 |
| example 4 | | | | | | | | | | |
| Working | 5 | 82.87 | | | | 7 | 10 | | 0.1 | 0.03 |
| example 5 | | | | | | | | | | |
| Working | 6 | 73.87 | 16 | | | | 10 | | 0.1 | 0.03 |
| example 6 | | | | | | | | | | |
| Working | 7 | 63.87 | 16 | 5 | 5 | | 10 | | 0.1 | 0.03 |
| example 7 | | | | | | | | | | |
| Working | 8 | 68.87 | 16 | | 5 | | 10 | | 0.1 | 0.03 |
| example 8 | | | | | | | | | | |
| Working | 9 | 63.87 | 16 | | 10 | | 10 | | 0.1 | 0.03 |
| example 9 | | | | | | | | | | |
| Working | 10 | 77.87 | 12 | | | | 10 | | 0.1 | 0.03 |
| example 10 | | | | | | | | | | |

### Comparative Example—No Vinyl Norbornene

### Working Examples 11—Thin Film Preparation (Spin Coating+UV Curing)

Thin film samples 1 to 10 of the compositions from working examples 1 to 10 are prepared by spin coating the compositions from working examples 1 to 10 each separately in a glovebox under nitrogen on pre-cleaned Quartz substrates. The wet films are then illuminated with UV light of 395 nm to cure the film, the dose applied is in general between 1 and 5 J/cm², the exact dose used is summarized in Table 2. The spin coating parameters are optimized to obtain a cured films thickness of 8 μm. The film thickness is determined by profilometry after curing the film as the height difference between the film surface and the substrate surface (after scratching with a scalpel) with a stylus-type profilometer. Then film samples 1 to 10 are obtained.

### Comparative Example 2—Thin Film Preparation (Spin Coating+UV Curing)

Thin film sample 1 of the comparative composition from comparative example 1 is fabricated in the same manner as described in working example 11 except for that the comparative composition from comparative example 1 is used instead of the compositions used in working example 11. Then, the film sample 1 is obtained.

### Curing Ratio Measurement

The cured material of each film samples is collected by scraping off the prepared film from the substrate and the material is analyzed by ATR-FTIR spectroscopy. The spectra is baseline corrected and normalized at the peak at 2851 cm⁻¹. The curing ratio is determined by integrating a monomer-specific vibration at 3058 cm⁻¹ and comparing it to the integral of the signal of the uncured formulation.

### HIT and EIT Measurement

The thin films on Quartz substrates are further analyzed by nanoindentation to determine material properties such as the elastic indentation modulus EIT, the indentation hardness HIT. An indenter is pressed into the test object with a defined force curve, the penetration depth is recorded. From the registered indentation depth, force applied and the shape of the indenter, various parameters can be calculated. The measurements are performed with a Fischerscope HM2000S (Loading Force=1 mN, Loading Time=8 sec, Creep=20 sec) and the instrument software is used to calculate EIT and HIT.

### Silicon Nitride Deposition and Haze Measurement

Onto the thin film samples from the spin coating experiments, 700 nm of silicon nitride (SiNx) is deposited by CVD.

After silicon nitride deposition, the haze of the resulting stack (quartz glass/cured polymer/SiNx) is determined according to ASTM D1003-21. The measurement is performed using the BYK Gardner Haze-Gard plus 4725 haze meter. The measurements are done at room temperature in air atmosphere.

Table 2 shows the results of the measurements.

TABLE 2

| | | Permitivity | Curing | | | | Haze after SiNx |
|---|---|---|---|---|---|---|---|
| | Sample | of the | dose | Curing | HIT | EIT | deposition by |
| Examples | No. | formulation | [J/cm²] | ratio [%] | [N/mm²] | [Mpa*10\hat{ } − 2] | CVD |
| Comparative | 0 | 2.32 | 1.5 | 96.9 | 11.82 | 12.39 | 47.06 |
| example 1 | | | | | | | |
| Working | 1 | 2.32 | 1.5 | 96.9 | 11.94 | 11.53 | 41.14 |
| example 1 | | | | | | | |
| Working | 2 | 2.31 | 1.5 | 91.9 | | | 36.76 |
| example 2 | | | | | | | |
| Working | 3 | 2.35 | 1.5 | 96 | | | |
| example 3 | | | | | | | |
| Working | 4 | 2.33 | 1.5 | 94 | 27.5 | 12.9 | 25.43 |
| example 4 | | | | | | | |
| Working | 5 | 2.4 | 1.5 | 95 | 7.94 | 14.38 | 29.36 |
| example 5 | | | | | | | |
| Working | 6 | 2.31 | 1.5 | 91.3 | 15.89 | 10.14 | 29.85 |
| example 6 | | | | | | | |
| Working | 7 | 2.34 | 1.5 | 91.9 | 13.51 | 10.89 | 27.04 |
| example 7 | | | | | | | |
| Working | 8 | 2.33 | 1.5 | 94.1 | 26.79 | 10.9 | 32.23 |
| example 8 | | | | | | | |
| Working | 9 | 2.36 | 1.5 | 94.4 | 9.23 | 15.14 | 27.81 |
| example 9 | | | | | | | |
| Working | 10 | 2.24 | 1.5 | 91.4 | 25.04 | 11.55 | 29.78 |
| example 10 | | | | | | | |

Although the invention has been illustrated by certain of the preceding examples, it is not to be construed as being limited thereby; but rather, the invention encompasses the generic area as hereinbefore disclosed. Various modifications and embodiments can be made without departing from the spirit and scope thereof.

1. A composition comprising at least:
a) a chemical compound of formula (I): 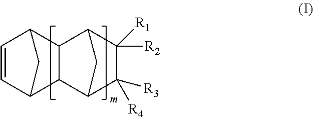
wherein:
m is an integer 0, 1 or 2;
R₁, R₂, R₃ and R₄ are the same or different and each independently selected from the group consisting of hydrogen, halogen, methyl, ethyl, linear or branched (C₃-C₁₆)alkyl, perfluoro(C₁-C₁₂)alkyl, hydroxy(C₁-C₁₆)alkyl, (C₃-C₁₂)cycloalkyl, (C₆-C₁₂)bicycloalkyl, (C₇-C₁₄)tricycloalkyl, (C₆-C₁₀)aryl, (C₆-C₁₀)aryl(C₁-C₆)alkyl, perfluoro(C₆-C₁₀)aryl, perfluoro(C₆-C₁₀)aryl(C₁-C₆)alkyl, tri(C₁-C₆)alkoxysilyl and a group of formula (A): 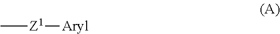
wherein:
Z¹ is a bond or a group selected from the group consisting of: (CR₅R₆)ₐ, O(CR₅R₆)ₐ, (CR₅R₆)ₐO, (CR₅R₆)ₐ—O—(CR₅R₆)_{b}, (CR₅R₆)ₐ—O—(SiR₅R₆)_{b}, (CR₅R₆)ₐ—(CO)O—(CR₅R₆)_{b}, (CR₅R₆)ₐ—O(CO)—(CR₅R₆)_{b}, (CR₅R₆)ₐ—(CO)—(CR₅R₆)_{b}, where a and b are integers which may be the same or different and each independently is 1 to 12;
R₅ and R₆ are the same or different and each independently selected from the group consisting of hydrogen, methyl, ethyl, linear or branched (C₃-C₆)alkyl, hydroxy, methoxy, ethoxy, linear or branched (C₃-C₆)alkyloxy, acetoxy, (C₂-C₆)acyl, hydroxymethyl, hydroxyethyl, linear or branched hydroxy(C₃-C₆)alkyl, phenyl and phenoxy;
Aryl is phenyl or phenyl substituted with one or more of groups selected from the group consisting of methyl, ethyl, linear or branched (C₃-C₆)alkyl, hydroxy, methoxy, ethoxy, linear or branched (C₃-C₆)alkyloxy, acetoxy, (C₂-C₆)acyl, hydroxymethyl, hydroxyethyl, linear or branched hydroxy(C₃-C₆)alkyl, phenyl and phenoxy;
b) an organo-ruthenium compound represented by formula (II): 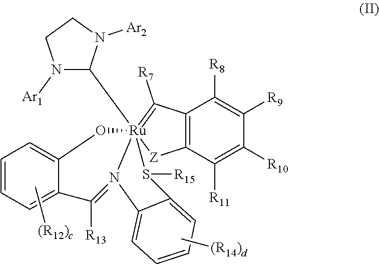
wherein
c and d are integers from 0 to 5;
Z is oxygen or sulfur;
R₇ is selected from the group consisting of hydrogen, (C₁-C₂₀)alkyl, (C₂-C₂₀)alkenyl, (C₂-C₂₀)alkynyl and (C₆-C₁₀)aryl; and
R₈, R₉, R₁₀ and R₁₁ are the same or different and each independently selected from the group consisting of hydrogen, halogen, (C₁-C₁₆)alkyl, (C₁-C₁₆)alkoxy, (C₁-C₁₆)perfluoroalkyl, (C₃-C₇)cycloalkyl, (C₂-C₁₆)alkenyl, (C₆-C₁₄)aryl, (C₆-C₁₄)perfluoroaryl, (C₃-C₁₂)heterocyclyl, —OR₁₆, —NO₂, —COOH, —COOR₁₆, —CONR₁₆R₁₇, —SO₂NR₁₆R₁₇, —SO₂R₁₆, —CHO, —COR₁₆, wherein R₁₆ and R₁₇ are the same or different and each independently selected from the group consisting of (C₁-C₆)alkyl, (C₁-C₆)perfluoroalkyl, (C₆-C₁₄)aryl, (C₆-C₁₄)perfluoroaryl; or wherein
two or more of R₈, R₉, R₁₀ and R₁₁ taken together with the carbon atoms to which they are attached to form a substituted or unsubstituted, fused (C₄-C₈)carbocyclic ring, or a substituted or unsubstituted, fused aromatic ring;
each R₁₂, R₁₃ and R₁₄ may be the same or different and independently of the other selected from the group consisting of hydrogen, halogen, (C₁-C₁₆)alkyl, (C₁-C₁₆)alkoxy, (C₁-C₁₆)perfluoroalkyl, (C₃-C₇)cycloalkyl, (C₂-C₁₆)alkenyl, (C₆-C₁₄)aryl, (C₆-C₁₄)perfluoroaryl, (C₃-C₁₂)heterocyclyl, —OR₁₆, —NO₂, —COOH, —COOR₁₆, —CONR₁₆R₁₇, —SO₂NR₁₆R₁₇, —SO₂R₁₆, —CHO, —COR₁₆, wherein R₁₆ and R₁₇ are the same or different and each independently selected from the group consisting of (C₁-C₆)alkyl, (C₁-C₆)perfluoroalkyl, (C₆-C₁₄)aryl, (C₆-C₁₄)perfluoroaryl;
R₁₅ is selected from the group consisting of (C₁-C₁₆)alkyl, (C₁-C₁₆)perfluoroalkyl, (C₃-C₁₆)cycloalkyl, (C₆-C₁₄)aryl, (C₆-C₁₄)perfluoroaryl and (C₃-C₁₂)heterocyclyl;
Ar₁ and Ar₂ are the same or different and each independently selected from the group consisting of substituted or unsubstituted phenyl, substituted or unsubstituted biphenyl and substituted or unsubstituted naphthyl, wherein each of said substituents are independently selected from the group consisting of methyl, ethyl and linear or branched (C₃-C₆)alkyl;
c) a photosensitizer represented by formula (III): 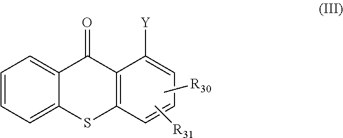
wherein
Y is halogen; and
R₃₀ and R₃₁ are the same or different and independently of each other selected from the group consisting of hydrogen, methyl, ethyl, linear or branched (C₃-C₁₂)alkyl, (C₃-C₁₂)cycloalkyl, (C₆-C₁₂)bicycloalkyl, (C₇-C₁₄)tricycloalkyl, (C₆-C₁₀)aryl, (C₆-C₁₀)aryl(C₁-C₃)alkyl, (C₁-C₁₂)alkoxy, (C₃-C₁₂)cycloalkoxy, (C₆-C₁₂)bicycloalkoxy, (C₇-C₁₄)tricycloalkoxy, (C₆-C₁₀)aryloxy(C₁-C₃)alkyl and (C₆-C₁₀)aryloxy; and
d) a chemical compound of formula (IV): 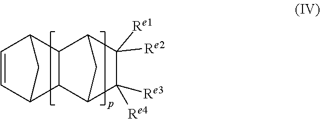
wherein
p is an integer 0, 1 or 2;
R^{e1}, R^{e2}, R^{e3} and R^{e4} are, each independently, selected from the group consisting of hydrogen, halogen, methyl, ethyl, linear (C₁-C₁₆)alkyl or branched (C₃-C₁₆)alkyl, perfluoro(C₁-C₁₂)alkyl, hydroxy(C₁-C₁₆)alkyl, (C₃-C₁₂)cycloalkyl, (C₆-C₁₂)bicycloalkyl, (C₇-C₁₄)tricycloalkyl, (C₆-C₁₀)aryl, (C₆-C₁₀)aryl(C₁-C₆)alkyl, perfluoro(C₆-C₁₀)aryl, perfluoro(C₆-C₁₀)aryl(C₁-C₆)alkyl, tri(C₁-C₆)alkoxysilyl, vinyl group, acrylate group, methacrylate group and an allyl group, linear (C₁-C₁₆)alkyl or branched (C₃-C₁₆)alkyl having a vinyl group, acrylate group, methacrylate group or an allyl group as the end group; and
wherein at least one of R^{e1}, R^{e2}, R^{e3} and R^{e4} is a vinyl group, acrylate group, methacrylate group, an allyl group, linear (C₁-C₁₆)alkyl or branched (C₃-C₁₆)alkyl having a vinyl group, acrylate group, methacrylate group or an allyl group as the end group.

2. The composition of claim 1, wherein the monomer of formula (IV) is selected from the group consisting of:

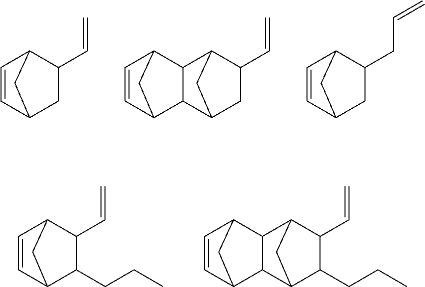

3. The composition of claim 1, wherein the monomer of formula (I) is selected from the group consisting of:

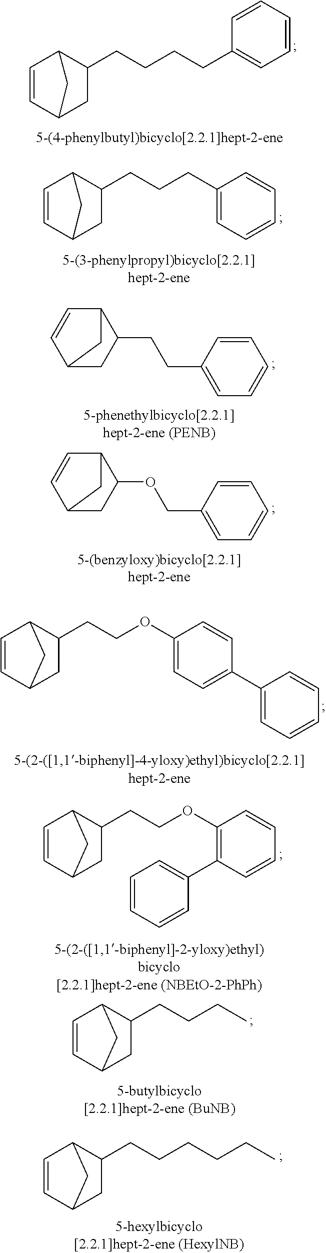

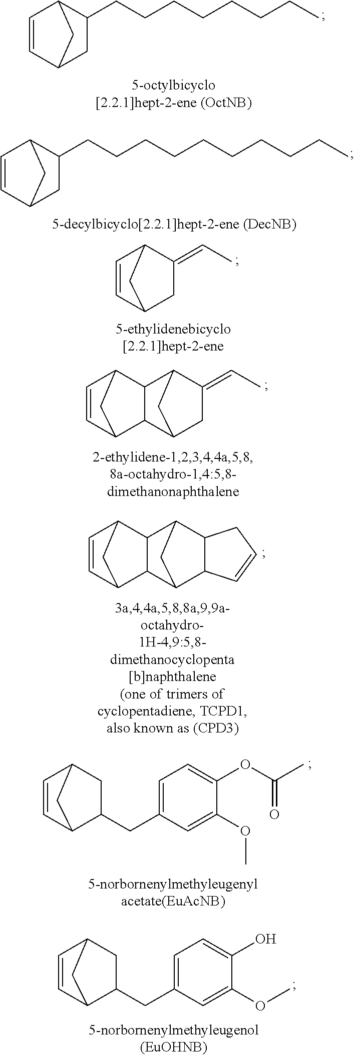

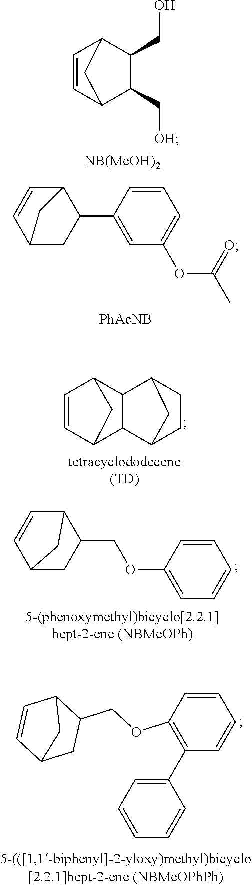 [SMILES: OC[C@@H]1C2C=CC(C2)[C@@H]1CO ; CC(=O)Oc1cccc(C2CC3C=CC2C3)c1 ; C1=CC2CC1C1C3CCC(C3)C21 ; C1=CC2CC1CC2COc1ccccc1 ; C1=CC2CC1CC2COc1ccccc1-c1ccccc1]

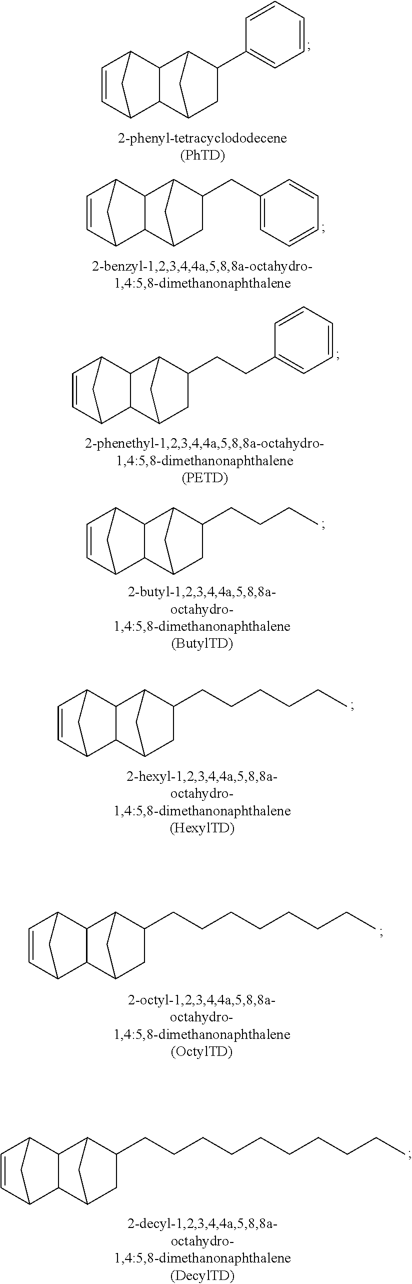

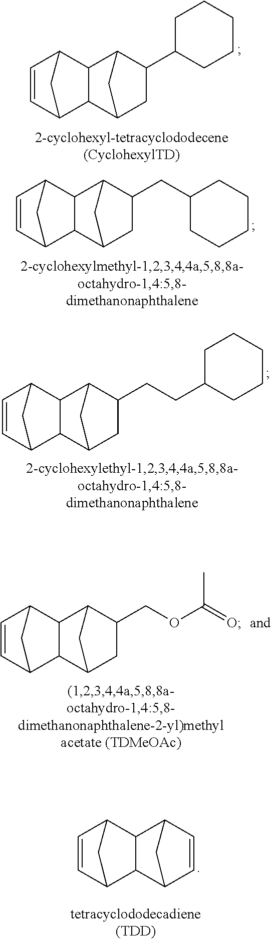

4. The composition of claim 1, wherein:
Z is oxygen;
R₇ is hydrogen;
R₈, R₉, R₁₀ and R₁₁ are the same or different and each independently selected from the group consisting of hydrogen, methyl, ethyl and —NO₂;
R₁₂, R₁₃ and R₁₄ are the same or different and each independently selected from the group consisting of hydrogen, methyl, ethyl and —NO₂;
R₁₅ is selected from the group consisting of methyl, ethyl and cyclohexyl; and
Ar₁ and Ar₂ are the same or different and each independently selected from the group consisting of phenyl, 2,6-dimethylphenyl, 2,6-diethylphenyl, 2,6-di(isopropyl)phenyl and 2,4,6-trimethylphenyl.

5. The composition of claim 4, wherein the organo-ruthenium compound is represented by formula (II) selected from the group consisting of: 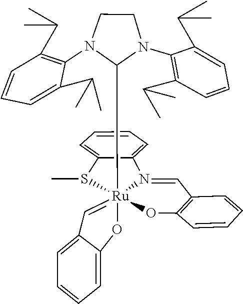
[1,3-Bis(2,6-diisopropylphenyl)-2-imidazolidinylidene]{2-[(E)-({2-[methylthio-κS]phenyl}imino-κN)methyl]phenoxido-κO}[2-(oxido-κO)benzylidene-κC]ruthenium(II) (Ru-1); 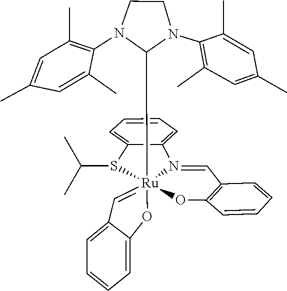
[1,3-Bis(2,4,6-trimethylphenyl)-2-imidazolidinylidene]{2-[(E)-({2-[isopropylthio-κS]phenyl}imino-κN)methyl]phenoxido-κO}[2-(oxido-κO)benzylidene-κC]ruthenium(II); 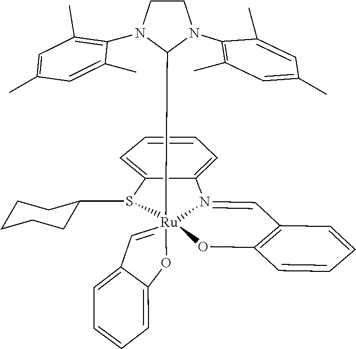
[1,3-Bis(2,4,6-trimethylphenyl)-2-imidazolidinylidene]{2-[(E)-({2-[cyclohexylthio-κS]phenyl}imino-κN)methyl]phenoxido-κO}[2-(oxido-κO)benzylidene-κC]ruthenium(II); and 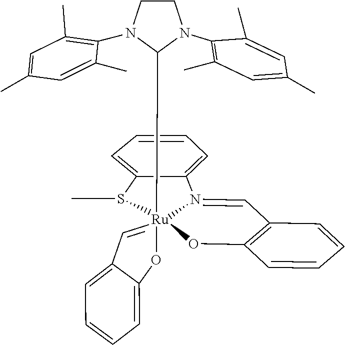
[1,3-Bis(2,4,6-trimethylphenyl)-2-imidazolidinylidene]{2-[(E)-({2-[methylthio-κS]phenyl}imino-κN)methyl]phenoxido-κO}[2-(oxido-κO)benzylidene-κC]ruthenium(II).

6. The composition of claim 1, wherein:
Y is chlorine or bromine; and
R₃₀ and R₃₁ are the same or different and independently of each other selected from the group consisting of hydrogen, methyl, ethyl, n-propyl, iso-propyl, phenyl, cyclohexyl, methoxy, ethoxy, n-propoxy and phenoxy.

7. The composition of claim 6, wherein the compound of formula (III) is selected from the group consisting of:

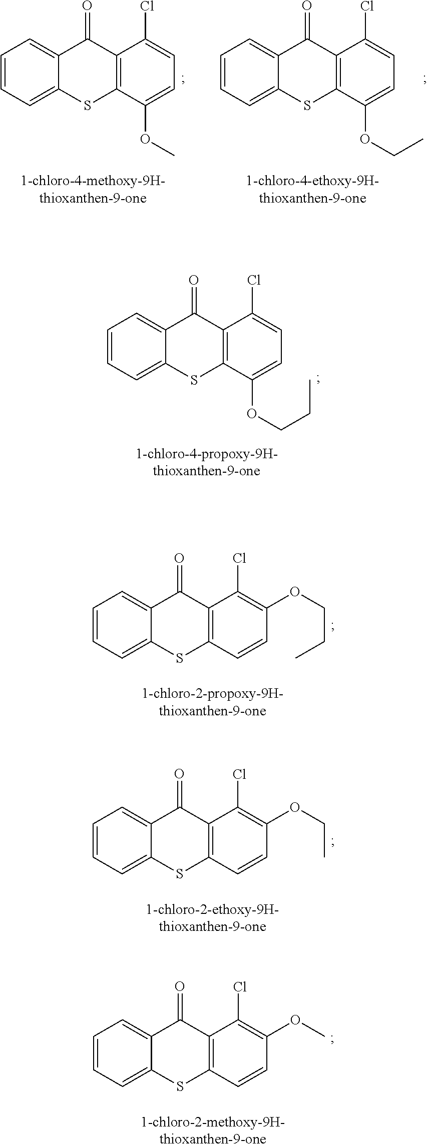

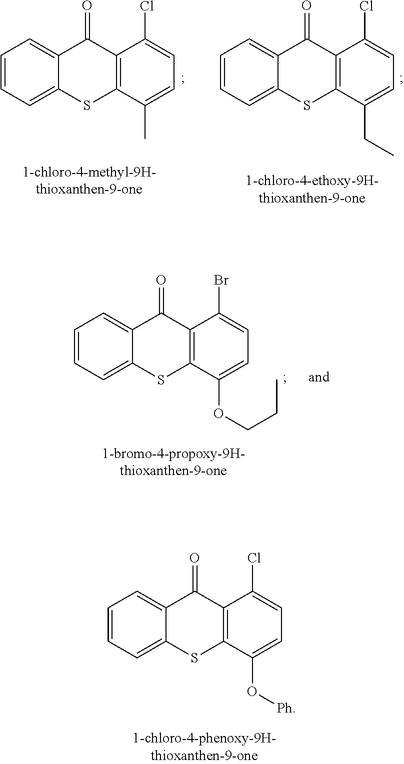

8. The composition of claim 1, further comprising a UV absorber and/or a crosslinker.

9. The composition of claim 1, further comprising an additive selected from:

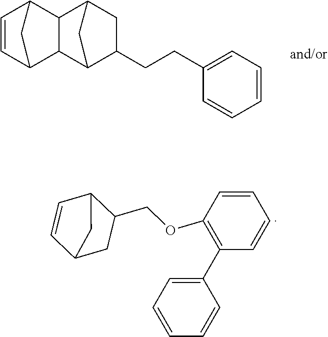

10. A method for fabricating a film comprising steps of,
(X^{a1}) providing a composition of claim 1 onto a substrate, a layer, or an outermost surface of a device to obtain a coated layer,
(X^{a2}) irradiating the coated layer with light to form a cured film.

11. A film formed from the composition of claim 1.

12. A film obtained by the method of claim 10.

13. The film of claim 11, wherein the film has a layer thickness in the range from 0.1 to 100 μm.

14. The film of claim 11, wherein the film has a relative permittivity value εᵣ<2.5.

15. The film of claim 11, wherein the film has a haze value 46 or less.

16. A device comprising at least the film of claim 11.

17. A method of forming a protection layer of a device, comprising:
photo curing a composition comprising a chemical compound of formula (IV): 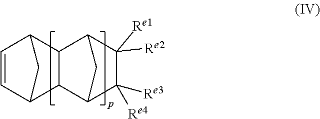
wherein
p is an integer 0, 1 or 2;
R^{e1}, R^{e2}, R^{e3} and R^{e4} are, each independently, selected from the group consisting of hydrogen, halogen, methyl, ethyl, linear (C₁-C₁₆)alkyl or branched (C₃-C₁₆)alkyl, perfluoro(C₁-C₁₂)alkyl, hydroxy(C₁-C₁₆)alkyl, (C₃-C₁₂)cycloalkyl, (C₆-C₁₂)bicycloalkyl, (C₇-C₁₄)tricycloalkyl, (C₆-C₁₀)aryl, (C₆-C₁₀)aryl(C₁-C₆)alkyl, perfluoro(C₆-C₁₀)aryl, perfluoro(C₆-C₁₀)aryl(C₁-C₆)alkyl, tri(C₁-C₆)alkoxysilyl, vinyl group, acrylate group, methacrylate group and an allyl group, linear (C₁-C₁₆)alkyl or branched (C₃-C₁₆)alkyl having a vinyl group, acrylate group, methacrylate group or an allyl group as the end group; and
wherein at least one of R^{e1}, R^{e2}, R^{e3} and R^{e4} is a vinyl group, acrylate group, methacrylate group, an allyl group, linear (C₁-C₁₆)alkyl or branched (C₃-C₁₆)alkyl having a vinyl group, acrylate group, methacrylate group or an allyl group as the end group.

18. The method of claim 10, wherein the coated layer is irradiated with light having a peak maximum wavelength in the range from 360 to 430 nm, and optionally, wherein the dose of the light irradiated to the composition is in the range from 1 to 5 J/cm².

19. The film of claim 13, the layer thickness is in the range from 5 to 10 μm.

20. The film of claim 14, wherein the relative permittivity value εᵣ is in the range from 2.0 to 2.4.
